(19) United States
(12) Patent Application Publication
(10) Pub. No.: US 2017/0316022 A1
(43) Pub. Date: Nov. 2, 2017

(54) CONTEXTUALLY-AWARE RESOURCE MANAGER

(71) Applicant: Microsoft Technology Licensing, LLC, Redmond, WA (US)

(72) Inventors: Neel Joshi, Kirkland, WA (US); William Hart Holmes, Seattle, WA (US); Paul David Tischhauser, Redmond, WA (US); Chandresh K. Jain, Sammamish, WA (US); Tor-Helge Persett, Seattle, WA (US); Eva Britta Karolina Burlin, Newcastle, WA (US); Dana Anne Lee, Seattle, WA (US); Joan Ching Li, Seattle, WA (US)

(21) Appl. No.: 15/142,574

(22) Filed: Apr. 29, 2016

(51) Int. Cl. G06F 17/30; G06Q 10/10

(52) U.S. Cl. CPC G06F 17/3097; G06Q 10/1095; G06F 17/30241; G06F 17/30528

(57) ABSTRACT

Techniques provide a contextually-aware resource manager. In response to one or more events, such as the creation or modification of a calendar event, one or more contextually-aware recommendations are generated and displayed to a user. For example, a recommendation can include the names of service providers, the names of customers, time slots for one or more calendar events, and notifications of one or more conditions. The recommendation can be based on data defining a level of eligibility for service providers and customers. The level of eligibility can be determined by a wide range of contextual data, including but not limited to traffic data, payment data, location data, map data, preference data, scheduling data, workload data, work history data, status data, skill set data, or weather data. The techniques assist user interaction with a computing device, and among other benefits, saves computing resources and reduce the number of inadvertent user entries.

### BACKGROUND

When scheduling appointments, computer users can be presented with a number of challenging tasks. For instance, when coordinating aspects of a project involving service providers, a user may have to create a number of calendar events pertaining to various stages of a project, and each stage of a project may be associated with different service providers. Each time a calendar event is generated, the user must identify an appropriate provider, determine if the provider is available, and then coordinate a time and date that is suitable for all involved parties. Such tasks can be further challenged by the fact that some projects require particular skillsets, thus requiring some due diligence to determine if a selected provider is a good match for the relevant requirements.

Some existing calendaring systems leave much to be desired in the scenarios described above. The shortcomings of the existing feature base require manual data entry and repetitive tasks, which are highly inefficient when it comes to time and computing resources. In addition, inefficient use of any calendaring program can cause a cascading set of issues, which can cause other inefficiencies.

It is with respect to these and other considerations that the disclosure made herein is presented.

### SUMMARY

Techniques described herein provide a contextually-aware resource manager. In response to one or more events, such as the receipt of contextual data or the creation or modification of a calendar event, one or more contextually-aware recommendations are generated, processed, and displayed to a user. For example, a recommendation can include the names of service providers, the names of customers, time slots for one or more calendar events, and notifications of one or more conditions or solutions. A recommendation can be based on contextual data related to factors affecting one or more aspects of a calendar event. A recommendation can also be based on goals defined in customer-defined preferences and provider-defined preferences. A recommendation can be displayed to a user for verification and/or selection. A selection of a recommendation can cause one or more actions to mitigate a conflict or resolve a condition.

The one or more actions can include a generation, modification, and/or communication of reminders, notifications, calendar events, documents, emails, text messages, and other data objects. The techniques disclosed herein can generate specialized communication such as thank you messages, greetings, introductions, etc. In addition, the techniques can utilize contextual data to execute other actions, e.g., automatically select providers for termination, automatically select providers for promotions, automatically select customers for termination, etc.

The techniques disclosed herein assist users with their interaction with a computing device, which among other benefits, saves computing resources and reduce the number of inadvertent user entries. In addition, the techniques disclosed herein enable customers to identify one or more providers that helps them achieve one or more goals. Yet further, the techniques disclosed herein enable providers to identify one or more customers that helps them achieve one or more goals.

The generation of one or more recommendations can be based on data defining a level of eligibility for service providers and customers. The level of eligibility can be determined by a wide range of contextual data and input data obtained from a number of resources. The contextual data can be related to service providers and customers including, but not limited to, data defining a prior work history between two or more entities, commute projections, scheduling conflicts, payment histories, credit histories, an availability of one or more parties, a location of a project, travel time to an appointment, preferred business hours, the availability of one or more entities, performance metrics, customer preferences, vendor preferences, workflow definitions, and combinations thereof. The contextual data can also include traffic data, weather data, and other data that can impact a schedule and/or a commute of a service provider or a consumer.

The techniques disclosed herein can also utilize data that quantifies a value of a customer or a value of a vendor. As will be described below, identified patterns of contextual data can be used to generate a number of recommendations and a level of eligibility associated with each recommendation. In some configurations, the input data, contextual data, and/or other data, can be used to generate a ranked list of items. Individual items on a ranked list include a recommendation for a customer, a provider, a timeslot, a notification, and other forms of recommendations described herein.

The input data can include scheduling data, such as, a date and a time. In some configurations, the input data can include an indication of a service category or a topic, e.g., auto repair, lawn care, legal services, etc. The service category, for example, can be processed to identify providers having an appropriate skill set. Contextual data including map data, location data, weather data, scheduling data, and other data can determine which of the identified providers has the best alignment with a customer. As will be described below, the map data and location data can be used to determine a probability associated with a commute for a given appointment. The probability and other factors can be used to select and rank providers and/or customers that can be a part of a recommendation. An individual recommendation can include providers, customers, timeslots and/or other options for taking one or more actions. A number of recommendations can be generated, ranked and displayed to a user for selection. A selected action can cause the generation, modification, and/or communication of reminders, notifications, calendar events, documents, emails, and other forms of communication.

Recommendations can be selected, ranked, and otherwise processed according to one or more sets of criteria. The criteria can be based on customer-defined preferences, provider-defined preferences and/or generated by the use of contextual data from multiple sources.

In some configurations, customer preferences and provider preferences can be used to influence a ranking of a provider, a customer or other items of a list. For instance, customer preferences can define one or more priorities, which may include cost savings, work quality, etc. The preferences can be analyzed with other contextual data, such as work history data defining performance history data and billing data. The ranking of a provider can be adjusted based, at least in part, on an analysis of contextual data associated with the provider in view of the customer's preferences.

In some configurations, provider preferences can define one or more priorities, which may include a desire to obtain high-volume customers, high-profile customers, and/or customers having a threshold credit score. Combinations of priorities enable service providers to identify customers having a “lifetime value” that meet or exceed a threshold. The ranking of a customer or a related item can be adjusted based, at least in part, on an analysis of contextual data associated with the customer in view of the provider's preferences. In addition, the techniques can use such data to take other actions, e.g., automatically select customers for termination, automatically select customers for special pricing, etc.

The ranking and/or selection of service providers, customers and other items may be based on a contextual interpretation of the user comments or other data such as a category of work selected by the user. The comments may be from social networks, text messages, emails, and other resources. The ranking and/or selection of the service providers can be based such contextual data in combination with other contextual data such as data indicating the availability of one or more parties, the ratings of one or more parties, data indicating prior relationships, data indicating relationship to others users, etc. The scheduling data or preference data can also include data indicating a priority and/or data defining a level of the “interruptability.” A ranking and/or selection of a provider, customer or other item, can be based on such data.

An analysis of contextual data, such as scheduling data, can enable the system to generate calendar events and mitigate scheduling conflicts. An analysis of contextual data, such as map data, traffic data, location data, weather data, map data, scheduling data, workload data, work history data, payment data, and specialty data can be used to identify and rank candidate time slots for suggested calendar events. Use of such contextual data can benefit one or more parties. Among many other benefits, for example, recommendations generated by the techniques disclosed herein can be used to mitigate scheduling conflicts, reduce commutes, and increase the probability that users can successfully commute between appointments.

It should be appreciated that the above-described subject matter may also be implemented as a computer-controlled apparatus, a computer process, a computing system, or as an article of manufacture such as a computer-readable medium. These and various other features will be apparent from a reading of the following Detailed Description and a review of the associated drawings. This Summary is provided to introduce a selection of concepts in a simplified form that are further described below in the Detailed Description.

This Summary is not intended to identify key features or essential features of the claimed subject matter, nor is it intended that this Summary be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

The detailed description is described with reference to the accompanying figures. In the figures, the left-most digit(s) of a reference number identifies the figure in which the reference number first appears. The same reference numbers in different figures indicates similar or identical items.

FIG. 1 is a block diagram showing an illustrative system for providing a contextually-aware resource manager.

FIGS. 2A-2B include screen diagrams showing an illustrative graphical user interface that is configured with graphical elements for receiving input data.

FIGS. 3A-3B include screen diagrams showing a graphical element configured to illustrate aspects of recommendations generated by the techniques disclosed herein.

FIG. 4 is a flow diagram showing a routine illustrating aspects of a mechanism disclosed herein for providing a contextually-aware resource manager.

FIG. 5 is a computer architecture diagram illustrating an illustrative computer hardware and software architecture for a computing system capable of implementing aspects of the techniques and technologies presented herein.

FIG. 6 is a diagram illustrating a distributed computing environment capable of implementing aspects of the techniques and technologies presented herein.

FIG. 7 is a computer architecture diagram illustrating a computing device architecture for a computing device capable of implementing aspects of the techniques and technologies presented herein.

### DETAILED DESCRIPTION

The following Detailed Description describes technologies providing contextually-aware resource manager. In response to one or more events, such as the receipt of contextual data or the creation or modification of a calendar event, one or more contextually-aware recommendations are generated, processed, and displayed to a user. For example, a recommendation can include the names of service providers, the names of customers, time slots for one or more calendar events, and notifications of one or more conditions or solutions. A recommendation can be based on contextual data related to factors affecting one or more aspects of a calendar event. A recommendation can also be based on goals defined in customer-defined preferences and provider-defined preferences. A recommendation can be displayed to a user for verification and/or selection. A selection of a recommendation can cause one or more actions to mitigate a conflict or resolve a condition.

The one or more actions can include a generation, modification, and/or communication of reminders, notifications, calendar events, documents, emails, text messages, and other data objects. The techniques disclosed herein can generate specialized communication such as thank you messages, greetings, introductions, etc. In addition, the techniques can utilize contextual data to execute other actions, e.g., automatically select providers for termination, automatically select providers for promotions, automatically select customers for termination, etc.

The techniques disclosed herein assist users with their interaction with a computing device, which among other benefits, saves computing resources and reduce the number of inadvertent user entries. In addition, the techniques disclosed herein enable customers to identify one or more providers that helps them achieve one or more goals. Yet further, the techniques disclosed herein enable providers to identify one or more customers that helps them achieve one or more goals.

The generation of one or more recommendations can be based on data defining a level of eligibility for service providers and customers. The level of eligibility can be determined by a wide range of contextual data and input data obtained from a number of resources. The contextual data can be related to service providers and customers including, but not limited to, data defining a prior work history between two or more entities, commute projections, scheduling conflicts, payment histories, credit histories, an availability of one or more parties, a location of a project, travel time to an appointment, preferred business hours, the availability of one or more entities, performance metrics, customer preferences, vendor preferences, workflow definitions, and combinations thereof. The contextual data can also include traffic data, weather data, and other data that can impact a schedule and/or a commute of a service provider or a consumer. The techniques disclosed herein can also utilize data that quantifies a value of a customer or a value of a vendor. As will be described below, identified patterns of contextual data can be used to generate a number of recommendations and a level of eligibility associated with each recommendation. In some configurations, the input data, contextual data, and/or other data, can be used to generate a ranked list of items. Individual items on a ranked list include a recommendation for a customer, a provider, a timeslot, a notification, and other forms of recommendations described herein.

The input data can include scheduling data, such as, a date and a time. In some configurations, the input data can include an indication of a service category or a topic, e.g., auto repair, lawn care, legal services, etc. The service category, for example, can be processed to identify providers having an appropriate skill set. Contextual data including map data, location data, weather data, scheduling data, and other data can determine which of the identified providers has the best alignment with a customer. As will be described below, the map data and location data can be used to determine a probability associated with a commute for a given appointment. The probability and other factors can be used to select and rank providers and/or customers that can be a part of a recommendation. An individual recommendation can include providers, customers, timeslots and/or other options for taking one or more actions. A number of recommendations can be generated, ranked and displayed to a user for selection. A selected action can cause the generation, modification, and/or communication of reminders, notifications, calendar events, documents, emails, and other forms of communication.

Recommendations can be selected, ranked, and otherwise processed according to one or more sets of criteria. The criteria can be based on customer-defined preferences, provider-defined preferences and/or generated by the use of contextual data from multiple sources.

In some configurations, customer preferences and provider preferences can be used to influence a ranking of a provider, a customer or other items of a list. For instance, customer preferences can define one or more priorities, which may include cost savings, work quality, etc. The preferences can be analyzed with other contextual data, such as work history data defining performance history data and billing data. The ranking of a provider can be adjusted based, at least in part, on an analysis of contextual data associated with the provider in view of the customer's preferences.

In some configurations, provider preferences can define one or more priorities, which may include a desire to obtain high-volume customers, high-profile customers, and/or customers having a threshold credit score. Combinations of priorities enable service providers to identify customers having a “lifetime value” that meet or exceed a threshold. The ranking of a customer or a related item can be adjusted based, at least in part, on an analysis of contextual data associated with the customer in view of the provider's preferences. In addition, the techniques can use such data to take other actions, e.g., automatically select customers for termination, automatically select customers for special pricing, etc.

The ranking and/or selection of service providers, customers and other items may be based on a contextual interpretation of the user comments or other data such as a category of work selected by the user. The comments may be from social networks, text messages, emails, and other resources. The ranking and/or selection of the service providers can be based such contextual data in combination with other contextual data such as data indicating the availability of one or more parties, the ratings of one or more parties, data indicating prior relationships, data indicating relationship to others users, etc. The scheduling data or preference data can also include data indicating a priority and/or data defining a level of the “interruptability.” A ranking and/or selection of a provider, customer or other item, can be based on such data.

An analysis of contextual data, such as scheduling data, can enable the system to generate calendar events and mitigate scheduling conflicts. An analysis of contextual data, such as map data, traffic data, location data, weather data, map data, scheduling data, workload data, work history data, payment data, and specialty data can be used to identify and rank candidate time slots for suggested calendar events. Use of such contextual data can benefit one or more parties. Among many other benefits, for example, recommendations generated by the techniques disclosed herein can be used to mitigate scheduling conflicts, reduce commutes, and increase the probability that users can successfully commute between appointments.

It should be appreciated that the above-described subject matter may be implemented as a computer-controlled apparatus, a computer process, a computing system, or as an article of manufacture such as a computer-readable storage medium. These and various other features will be apparent from a reading of the following Detailed Description and a review of the associated drawings. Furthermore, the claimed subject matter is not limited to implementations that solve any or all disadvantages noted in any part of this disclosure.

As will be described in more detail herein, it can be appreciated that implementations of the techniques and technologies described herein may include the use of solid state circuits, digital logic circuits, computer component, and/or software executing on one or more devices. Signals described herein may include analog and/or digital signals for communicating a changed state, movement and/or any data associated with motion detection. Gestures captured by users of the computing devices can use any type of sensor or input device.

While the subject matter described herein is presented in the general context of program modules that execute in conjunction with the execution of an operating system and application programs on a computer system, those skilled in the art will recognize that other implementations may be performed in combination with other types of program modules. Generally, program modules include routines, programs, components, data structures, and other types of structures that perform particular tasks or implement particular abstract data types. Moreover, those skilled in the art will appreciate that the subject matter described herein may be practiced with other computer system configurations, including hand-held devices, multiprocessor systems, microprocessor-based or programmable consumer electronics, minicomputers, mainframe computers, and the like.

By the use of the technologies described herein, contextual data from a number of resources can be utilized to provide a contextually-aware resource manager. Such technologies can improve user interaction with a computing device by automatically suggesting recommendations that are contextually relevant to a relationship between two or more parties. Configurations can be beneficial in assisting users coordinating aspects of a project, such as calendar events, particularly when a user has a large number of events to schedule. Among many benefits provided by the technologies described herein, a user's interaction with a device may be improved, which may reduce the number of inadvertent inputs, reduce the consumption of processing resources, and mitigate the use of network resources. Other technical effects other than those mentioned herein can also be realized from implementations of the technologies disclosed herein.

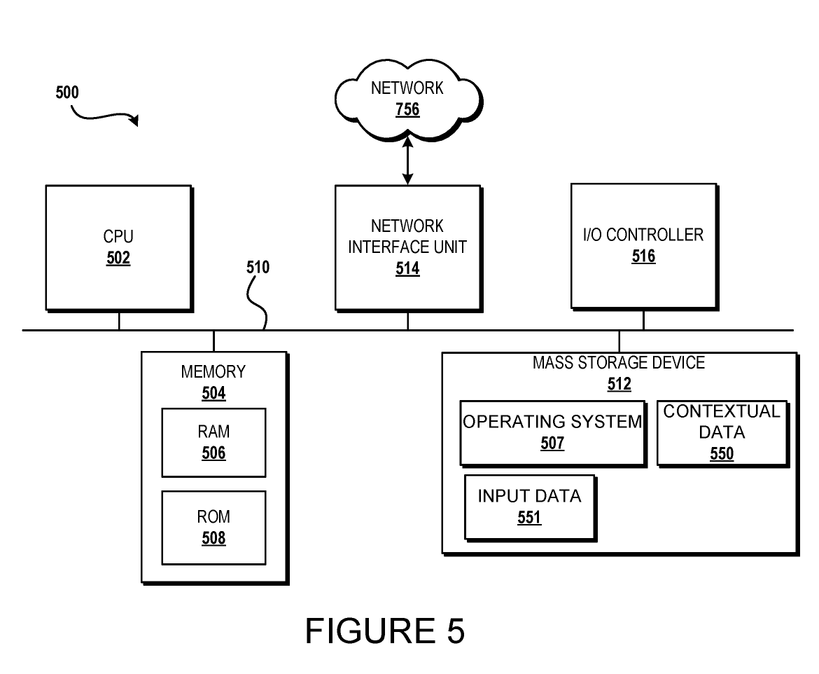

In the following detailed description, references are made to the accompanying drawings that form a part hereof, and in which are shown by way of illustration specific configurations or examples. Referring now to the drawings, in which like numerals represent like elements throughout the several figures, aspects of a computing system, computer-readable storage medium, and computer-implemented methodologies for providing a contextually-aware resource manager. As will be described in more detail below with respect to FIGS. 5-7, there are a number of applications and services that can embody the functionality and techniques described herein.

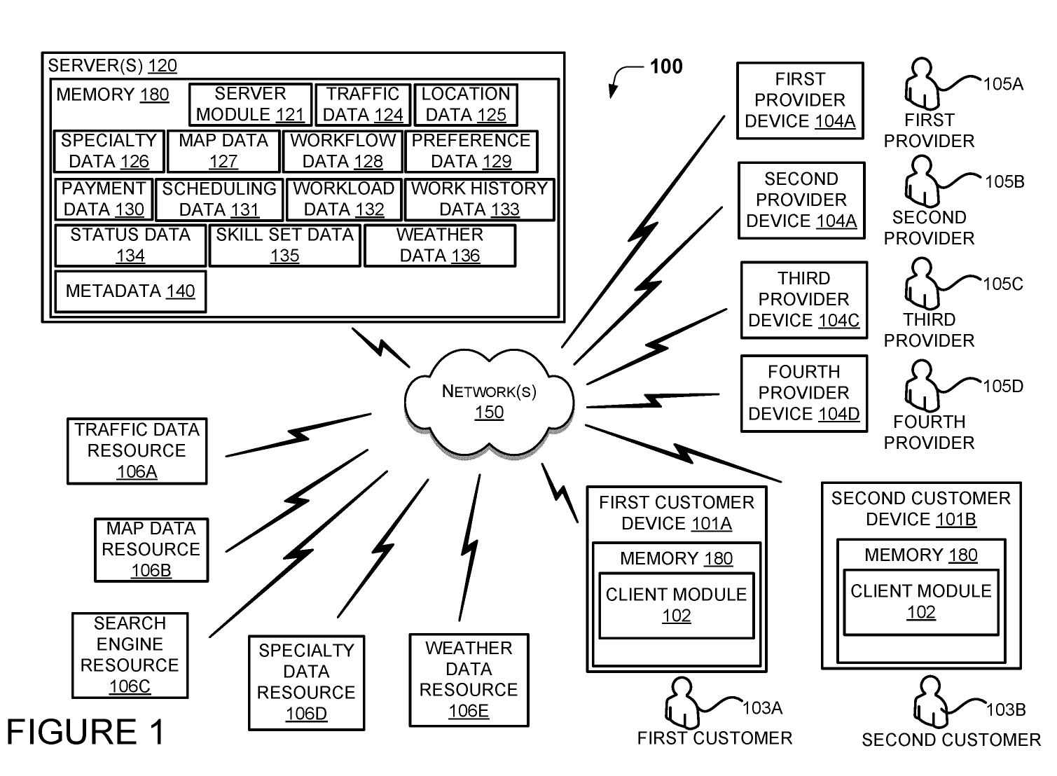

FIG. 1 is a block diagram showing aspects of one example environment 100, also referred to herein as a “system 100,” disclosed herein for providing a contextually-aware resource manager. In one illustrative example, the example environment 100 can include one or more servers 120, one or more networks 150, one or more customer devices 101A-101B (collectively “customer devices 101”), one or more provider devices 104A-104D (collectively “provider devices 104”), and one or more resources 106A-106E (collectively “resources 106”). The customer devices 101 can be utilized for interaction with one or more customers 103A-103B (collectively “customers 103”), and the provider devices 104 can be utilized for interaction with one or more service providers 105A-105D (collectively “service providers 105”). This example is provided for illustrative purposes and is not to be construed as limiting. It can be appreciated that the example environment 100 can include any number of devices, customers, providers, and/or any number of servers 120.

For illustrative purposes, the service providers 105 can be a company, person, or any type of entity capable of providing services or products for the customers 103, which can also be a company, person or other entity. For illustrative purposes, the service providers 105 and the customers 103 can be generically and individually referred to herein as “users.” In general, the techniques disclosed herein enable users to utilize contextual data from a number of resources 106 to generate workflow data 128 and other data objects related to the workflow data 128. In some configurations, a data object may include one or more calendar events related to stages of the workflow. Contextual data can be analyzed to determine one or more candidate timeslots for individual stages. The candidate timeslots can be ranked based on contextual data and a ranked list of candidate timeslots can be presented to the user for selection.

The customer devices 101, provider devices 104, servers 120 and/or any other computer configured with the features disclosed herein can be interconnected through one or more local and/or wide area networks, such as the network 150. In addition, the computing devices can communicate using any technology, such as BLUETOOTH, WIFI, WIFI DIRECT, NFC or any other suitable technology, which may include light-based, wired, or wireless technologies. It should be appreciated that many more types of connections may be utilized than described herein.

A customer device 101 or a provider device 104 (collectively “computing devices”) can operate as a stand-alone device, or such devices can operate in conjunction with other computers, such as the one or more servers 120. Individual computing devices can be in the form of a personal computer, mobile phone, tablet, wearable computer, including a head-mounted display (HMD) or watch, or any other computing device having components for interacting with one or more users and/or remote computers. In one illustrative example, the customer device 101 and the provider device 104 can include a local memory 180, also referred to herein as a “computer-readable storage medium,” configured to store data, such as a client module 102 and other contextual data described herein.

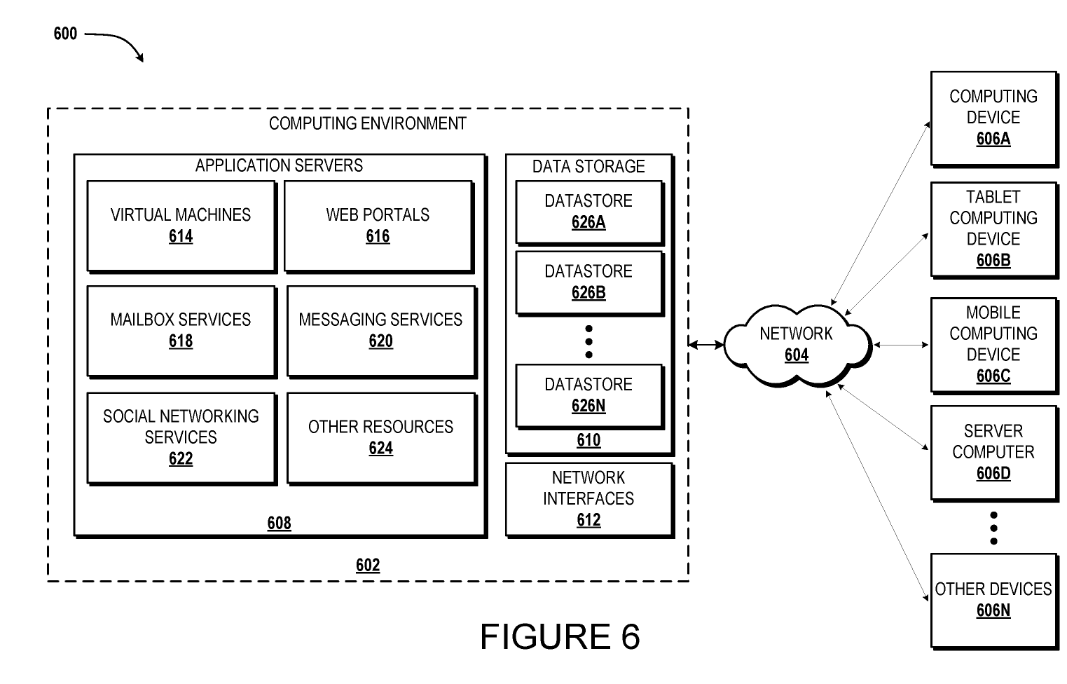

The servers 120 may be in the form of a personal computer, server farm, large-scale system or any other computing system having components for processing, coordinating, collecting, storing, and/or communicating data between one or more computing device. In one illustrative example, the servers 120 can include a local memory 180, also referred to herein as a “computer-readable storage medium,” configured to store data, such as a server module 121 and other data described herein. The servers 120 can also include components and services, such as the application services and shown in FIG. 6, for providing, receiving, and processing contextual data and executing one or more aspects of the techniques described herein. As will be described in more detail herein, any suitable module may operate in conjunction with other modules or devices to implement aspects of the techniques disclosed herein.

In some configurations, an application programming interface 199 (“API”) exposes an interface through which an operating system and application programs executing on the computing devices can enable the functionality disclosed herein. Through the use of this data interface and other interfaces, the operating system and application programs can communicate and process contextual data to modify scheduling data as described herein.

The system 100 may include a number of resources, such as a traffic data resource 106A, map data resource 106B, search engine resource 106C, specialty data resource 106D, and a weather data resource 106E (collectively referred to herein as “resources 106”). The resources 106 can be a part of the servers 120 or separate from the servers 120, and the resources 106 can provide contextual data, including traffic data 124, location data 125, specialty data 126, map data 127, workflow data 128, preference data 129, payment data 130, scheduling data 131, workload data 132, work history data 133, status data 134, skill set data 135, weather data 136, and other data described herein. The metadata 140 can include, but is not limited to, a person's name, a company name, contact information, location data, and any other data related to a provider 105 or a customer 103. In some configurations, the metadata 140 can include any format suitable for populating one or more data entry fields of a user interface.

These example resources 106 and contextual data are provided for illustrative purposes and are not to be construed as limiting. It can be appreciated that the techniques disclosed herein may utilize more or fewer resources 106 shown in FIG. 1. It can also be appreciated that some of the resources shown in FIG. 1 can obtain any type of contextual information from other resources such as social networks, e-commerce systems, government systems, and other like sources. For instance, sales data from e-commerce systems can be used to determine a performance indicator of a customer or a provider.

The scheduling data 131 can define appointments for the customers 103 and the providers 105. The scheduling data 131 can define a start time and an end time. The scheduling data 131 can also include location data 125 if an appointment is associated with a geographic location, global coordinates, an address, a room number and other information identifying a location. The scheduling data 131 can define a single appointment or a series of appointments. In addition, the scheduling data 131 can include communication information such as a phone number, IM address, URL, or other information for facilitating a voice or video conference. The scheduling data 131 can also include a text description of an appointment and other data indicating a topic, service category, a customer 103 and/or a provider 105. The scheduling data 131 can be stored on the server 120, customer device 101, provider device 104, or any suitable computing device, which may include a Web-based service.

The map data 127 can define roads and other types of travel paths within a geographic area. The map data 127 can also include topography data and other data that may influence a commute of a user from one location to another. The map data 127 can also include data defining buildings, homes, and other landmarks. The map data 127 can also include image data which may include a satellite image of the roads and paths within a geographic area as well as images of buildings, homes and other landmarks. The map data 127 may be from a number of resources, including a web-based service, government services, or other resources.

The traffic data 124 can include real-time updates on vehicle traffic within a geographic area. The traffic data 124 can also include historical travel data that can be used to predict travel times between two or more locations. The traffic data 124 can be in any suitable format for defining projected travel times between two or more locations that considers a time of travel, weather at a time of travel, traffic at a time of travel, and other factors that may influence a projected travel time. For example, the traffic data 124 can include updates with respect to road closures, delays, construction, new roads, or other scenarios that can impact activity with respect to a calendar event. The traffic data 124 may be from a number of resources, including a web-based service, government services, or other resources.

The weather data 136 can include current, historical, and forecast data indicating weather conditions. The weather data 136 can include data with respect to wind, precipitation, temperature and other conditions that may influence a commute from one location to another. The weather data 136 can be in any suitable format for enabling the projection of travel times between two or more locations. The weather data 136 may be from a number of resources, including a web-based service, government services, or other resources.

The specialty data 126 can include information pertaining to a specialization, subject, topic, one or more industries, or an area of interest. For example, specialty data 126 may include details relating to a medical topic, such as pediatrics, dentistry, etc. In other examples, the specialty data 126 may relate to diseases, cures, conditions, and other like topics. The specialty data 126 can be obtained from a number of different resources including web-based resources such as sites provided by WebMD, American Medical Association, and the Center of Disease Control. These examples are provided for illustrative purposes and are not to be construed as limiting, as the specialty data 126 can be related to any topic or areas of interest.

The workflow data 128 can define a multi-step process and attribute definitions within each step of the process. The workflow data 128 can be obtained from a number of different resources including web-based resources. In addition, the workflow data 128 can be derived from other data such as the specialty data 126. For example, specialty data 126 that pertains to pediatrics can be analyzed to determine a process that involves a number of steps which may include immunization shots, follow-up exams, and other milestones and tasks that are recommended at certain times.

The workload data 132 may include a listing of a number of services, projects, or appointments that are scheduled for a provider. For example, the workload data 132 may list a number of projects that are currently scheduled for a company. The workload data 132 can also be based on scheduling data 131, such as a number of appointments that are scheduled for a doctor. The workload data 131 can also define one or more thresholds. Such data can be used to determine if a company or individual is at, below, or above a given capacity. In some configurations, the workload data 132 defines a value indicating an ability of the individual provider relative to a predetermined workload capacity.

The skill set data 135 identifies and quantifies a range of skills and/or abilities of a particular company or individual. The skill set data 135 may include a hierarchy of data that identifies an industry, specializations within an industry, and details with respect to these specific projects that have been performed in the past. For instance, the skill set data 135 may identify a company as a construction company capable of performing particular types of renovations. The skill set data 135 may also provide details with respect to particular renovation projects and specialized features related to those projects. The skill set data 135 can apply to any company or individual related to any industry.

The work history data 133 can include performance indicators related to a provider 105 or a customer 103. For instance, the work history data 133 can indicate the quality of one or more projects performed by a provider 105. Work history data 133 can include an array of different performance indicators, which may relate to timeliness, productivity, accuracy, price, other indicators and combinations thereof. In other examples, the work history data 133 can indicate performance indicators associated with customers 103. In such examples, a customer 103 can be associated with an array of different performance indicators which may relate to a credit score or any other score associated with the behavior of a company, an individual or a group of individuals.

The payment data 130 can include a record of payments that are made between two or more parties. The payment data 130 can also include data indicating the timeliness in which payments are made. The payment data 130 can include a credit score or any other data that indicates a reliability and/or ability to make timely payments.

The status data 134 can define the availability of one or more parties. For instance, status data 134 can indicate if a party is unavailable, available, or unavailable until a particular date. The status data 134 can also define a level of availability. These examples are provided for illustrative purposes and are not to be construed as limiting. It can be appreciated that the status data 134 include a form of data indicating the availability of a company, an individual or a group of individuals.

The preference data 129 can include customer-defined preferences or provider-defined preferences. In some configurations, the preference data 129 can include a number of weighted parameters that indicate priorities, preferences, and/or goals. For instance, a provider 105 may indicate that they are interested in identifying customers that are timely with respect to appointments. In other examples, a provider 105 may indicate that they are interested in customers having good credit or customers that may have a particular payment history. In some configurations, provider-defined preferences can include a combination of parameters and/or priorities enabling the system 100 to identify, select, and rank customers having a long-term value or a short-term value to a provider. In one illustrative example, provider-defined preferences may identify a number of performance metrics with respect to customers and each performance metric can be weighted to enable a provider 105 to identify customers having a “high lifetime value.” Such preferences can be configured for providers desiring to acquire customers that can benefit their company with respect to long-term goals. The preference data 129 can include provider-defined preferences enabling the system 100 to identify, select, and rank high-volume customers, high-profile customers, and other types of customers or users that fit one or more business models. In addition to identifying preferred customers, the techniques disclosed herein can also enable a provider to “fire,” e.g., terminate a relationship with, unwanted customers.

In some configurations, the preference data 129 can help customers identify and/or terminate providers. In some configurations, customer-defined preferences may indicate they are interested in identifying providers 105 having a particular quality rating. The preference data 129 can also include other data to indicate a combination of parameters, goals, and/or priorities. For instance, the preference data 129 can include customer-defined preferences enabling the system 100 to identify, select, and rank high-volume providers, high-profile providers, and other types of providers that meet the needs of a customer.

The preference data 129 can also define a value indicating a level of “interruptability” of a particular project, job, appointment, or event. As will be described in the examples provided herein, a customer 103 or a provider 105 can indicate if a particular calendar event can be interrupted by other calendar event proposals. Such features enable the techniques disclosed herein to resolve conflicts between calendar events and identify alternative plans if conflicts arise.

It can be appreciated that a level of interruptability, priority or other preferences for a calendar event can be from a number of sources. For instance, a priority or a level of interruptability can be communicated when a calendar event is created. In some configurations, a priority for a calendar event can be based on a priority indicated by a sender of a calendar event. In such an example, a user entering input data can indicate a priority or a level of interruptability. In addition, a priority for a calendar event can be based on a priority established by a recipient of the calendar event. In such an example, a recipient may accept an invitation for an appointment and provide input data indicating a priority and/or a level of interruptability. A priority and/or a level of interruptability can also be a combination of inputs from the sender and recipient of a calendar event.

To enable aspects of the techniques disclosed herein, one or more computing devices of FIG. 1 can be configured to generate data defining one or more recommendations in response to detecting the presence of a condition. In some configurations, implementations can include receiving scheduling data defining a calendar event. In addition, the implementations can include obtaining contextual data from a plurality of resources. As described in more detail herein, the contextual data can include additional scheduling data, workload data, work history data, payment data, weather data, map data, traffic data, location data and/or other data that relating to a calendar event.

One or more computing devices can be configured to identify a pattern of the contextual data, which includes scheduling data 131, indicating a presence of a condition that affects one or more aspects of a calendar event. A condition can include weather conditions, traffic conditions, the introduction or modification of a calendar event that causes one or more scheduling conflicts, and/or other events or data that can impact aspects of a calendar event. The weather conditions and traffic conditions can include real-time updates or forecasts. Based on the detected condition, one or more recommendations can be generated. The following description includes examples of conditions that cause a computing device to take one or more actions, such as the generation of a recommendation.

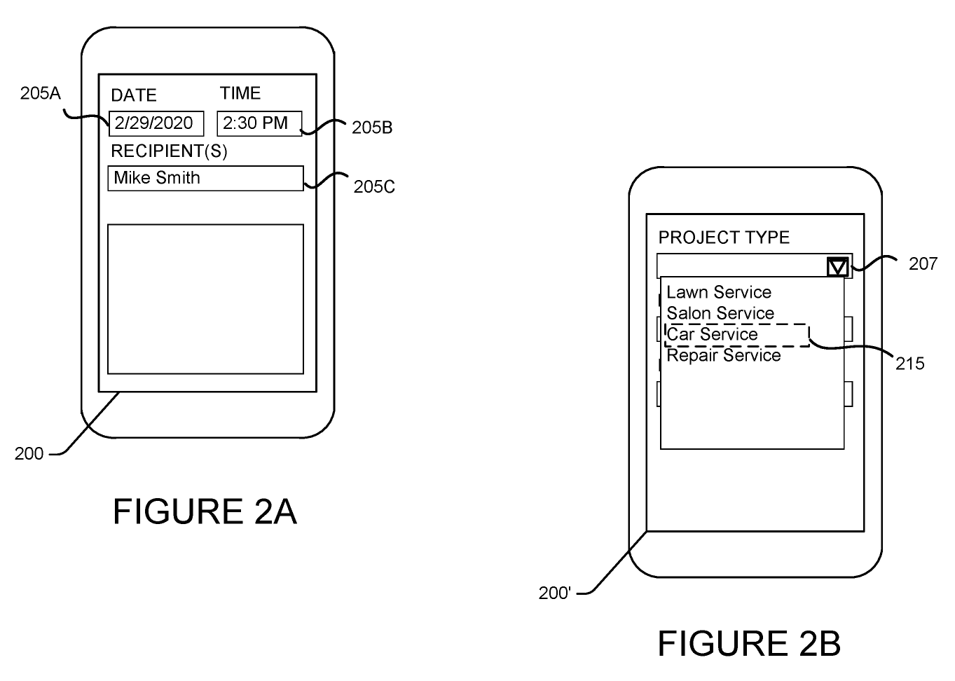

Turning now to FIGS. 2A-2B, an example graphical user interface (UI) is configured to display and receive input data relating to the techniques disclosed herein. The example UI can be displayed to a user desiring to schedule a calendar event or otherwise provide input data. Although the following examples include project-related or calendar-related interfaces, it can be appreciated that techniques disclosed herein can be applied to any user interface configured to take any suitable form of input, including voice commands, movement gestures, etc. It can also be appreciated that the examples disclosed herein can apply to any type of user, e.g., a customer 103 or a provider 105.

FIG. 2A is a screen diagram showing an illustrative graphical UI 200 that is configured to display and receive input data. The UI 200 can be generated by client module 102, shown in FIG. 1, and presented on a computing device, such as a customer device 101 or a provider device 104.

As illustrated in FIG. 2A, the UI 200 includes a display of a number of graphical elements for receiving and displaying input data. In this example, the UI 200 includes a “date” UI element 205A for receiving a preferred appointment date, a “time” UI element 205B for receiving a preferred appointment time, and a “recipient” UI element 205C for receiving data specifying a name of at least one provider 105. Other configurations of the UI 200 can enable the receipt of other types of data, such as location data. The location related to the appointment can include, for example, a room number, an address, a street, city, state, or any other information indicating a location associated with the appointment.

In this example, the input data includes information such as a contact name and other information, such as a location and a time and a date. Such data can be analyzed to determine a topic of interest, a specialization, or a service category. For instance, specialty data 126 or skill set data 135 received from one or more resources can indicate that a particular provider is associated with a service category. In this example, it is a given that the “recipient,” Mike Smith, is a provider associated with car repair services. When such contextual data is processed with input data, such as the sample input data of FIG. 2A, the system 100 can determine a context associated with the input data. In this example, the recipient and location data can be used to generate data indicating a service category.

FIG. 2B illustrates another example UI 200′ showing other forms of input data. In this example, the UI 200′ includes a “project type” UI element 207 that is a pulldown menu having a number of items, where individual items indicate a service category. In this example, a user can provide input data by the selection of at least one item of the pull down menu 207. For illustrative purposes, the pulldown menu 207 includes: “Lawn Service,” “Salon Service,” “Car Service” and “Repair Service.” This example is provided for illustrative purposes not to be construed as limiting. It can be appreciated that other categories, topics or subjects can be listed and any other type of graphical element may be utilized by the techniques disclosed herein to receive input data, which may include a text entry field or another graphical element configured to receive input data or initiate a process for receiving a voice input. As shown in FIG. 2B, for illustrative purposes, the “Car Service” menu item 215 is selected. Such an action generates input data indicating a service category.

The examples of FIG. 2A and FIG. 2B are provided for illustrative purposes and is not to be construed as limiting. It can be appreciated that the input data can be in other forms, such as a text description indicating an interest to initiate a project, schedule a meeting, etc. The input data can be in any format, e.g., a text message, an email, or an audio file, or any format suitable for initiating a calendar event or indicating a topic or service category.

In response to obtaining the input data, the client module 102 of the customer device 101 can communicate the input data to the server 120 for processing. In a scenario, such as in the example of FIG. 2A, where the input data includes a provider name, the server 120 and/or the customer device 101 can cause an analysis of a database that aligns providers with a service category. The techniques herein can determine a service category by using the name or other identifying information provided in the input data.

After identifying the service category, or receiving input data indicating a service category, such as the example shown in FIG. 2B, the configurations disclosed herein can execute a number of actions. In one action, the system 100 can identify a number of providers based on the service category. Such a process can utilize the specialty data 126 and/or the skill set data 135. In addition, the system 100 can rank the providers, including any providers identified in the input data, based on one or more factors.

A ranked list of providers can be displayed as a recommendation. In addition, the configurations disclosed herein can also generate a recommendation for new appointment timeslots, adjustments to appointment timeslots, a new provider recommendation, a new customer recommendation, and/or a combination thereof.

The selection and/or ranking of individual providers can be based on a number of factors. For instance, the ranking of each provider may be based on contextual data, input data, and/or preference data 129. As summarized above, in some configurations, a selection and/or ranking of an individual provider can be based on a level of eligibility. The level of eligibility can be based on an analysis of contextual data, such as a provider's specialization, workload, prior work history, ability to commute to a particular location, and/or a combination of such data and other contextual data. The contextual data can also include map data, traffic data, weather data, and other contextual data that can be used to determine a level of eligibility for individual provider.

In some configurations, preferences of the customer and/or preferences of providers can be analyzed. For instance, preference data can define one or more customer-defined goals, which may include cost savings goals, work quality goals, time saving goals, etc. The preference data can be analyzed with other contextual data, such as work history data defining performance history data and/or billing data of a provider. The ranking of an individual provider can be adjusted based, at least in part, on an analysis of the preference data and the contextual data associated with the provider. For instance, if customer-defined preferences indicate work quality as a priority, individual providers having high quality ratings can rank higher than providers having low quality ratings. If a quality rating is above a certain threshold, associated providers can be automatically selected or placed in a ranked list.

In addition, techniques disclosed herein can analyze location data 125 and other data to rank one or more providers. For instance, providers associated with a location that is close to the customer's home or office may be ranked higher than providers that are located at a further distance. Traffic data 124 and other data may also be analyzed to determine the ranking of each provider. For instance, a provider having a commute that is not impacted by traffic may rank higher than a provider having a commute that is impacted by traffic. Additional details and examples of such configurations and other configurations for ranking providers on a list are provided in more detail below.

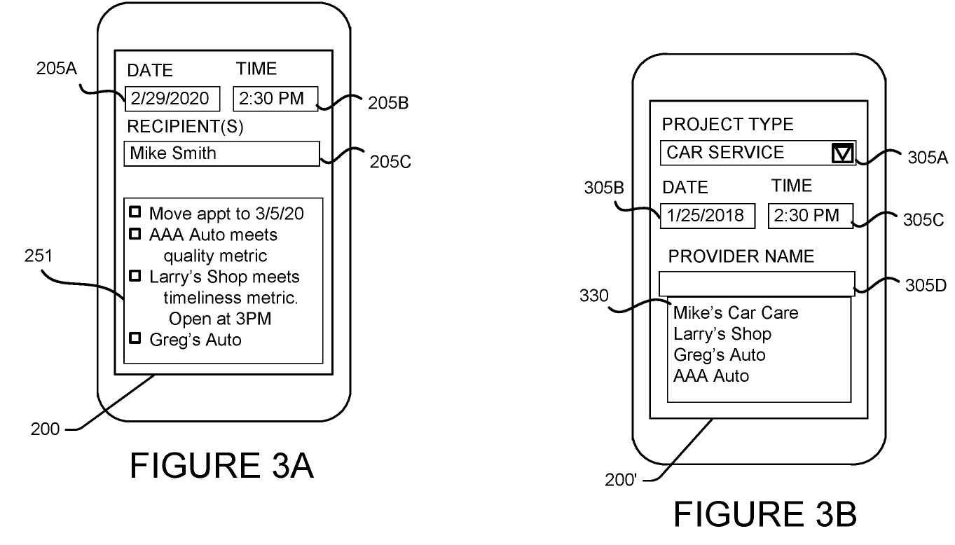

FIG. 3A illustrates an example of a graphical element including a ranked list of resolutions. In this example, the ranked list of resolutions includes a recommendation to move the appointment to a new date or time and a recommendation for other candidate providers. These examples are provided for illustrative purposes and are not to be construed as limiting.

In the example of FIG. 3A, the first recommendation suggests an alternative date for the calendar event defined in the input data. Such a recommendation may be generated if the system 100 identifies a scheduling conflict. The scheduling conflict may be detected by an analysis of the scheduling data of the recipient (the provider, Mike Smith) and/or an analysis of the scheduling data of the sender (the customer). The second recommendation suggests an alternative provider. Such a recommendation may be generated if the system 100 identifies a scheduling conflict with the recipient and/or if the system 100 identifies a provider that meet or exceeds a performance threshold defined by the customer, a computer, and/or any other entity. In this example, it is a given that the first alternative provider, AAA Auto, meets or exceeds a particular quality metric. The third recommendation suggests another alternative provider. In this example, it is a given that a second alternative provider meets or exceeds a timeliness metric. As shown, the second alternative provider, Larry's Shop, is displayed as a recommendation along with an alternative time. A third alternative provider, Greg's Auto is also displayed.

FIG. 3B illustrates one example of a ranked list 330 of providers. In this example a number of providers are listed: Mike's Car Care, Larry's Shop, Greg's Auto, and AAA auto. In this example, the ranked list 330 is displayed in proximity to at least one UI element configured to receive input data. The ranked list can be configured to receive a selection of one provider of the list. Once a provider is selected, the UI 200′ can then generate another list of recommendations, one similar to the recommendations of FIG. 3A, showing recommendations for a time and/or other candidate providers.

These examples are provided for illustrative purposes and are not to be construed as limiting. It can be appreciated that recommendations can include alternative providers, alternative times, alternative dates, and/or other suggestions. It can also be appreciated that the display recommendations may be ranked and/or selected based on other techniques described herein. For instance, a recommendation suggesting an alternative provider can be generated if the preference data of the provider is looking for customers meeting certain criteria. In one illustrative example, if the customer sending this example calendar event has a customer complaint record and/or a desired credit history that meets or exceeds criteria defined by a provider, such a provider may be displayed as part of a recommendation.

The analysis of the preference data can involve a simultaneous analysis of a number of different goals at any given time. Thus, customer goals and provider goals can be achieved within one or more recommendations. For example, if a particular provider has certain goals that indicate a need for certain types of customers, performance data associated with a customer can be evaluated to influence a ranking of a recommendation listing that particular provider. At the same time, if a customer has several goals relating to timeliness and quality, providers that meet such goals can be in a recommendation. The ranking of each recommendation suggesting the providers can be based on a value determined by any suitable technique for aligning performance data and one or more goals.

The recommendations can include new proposed dates based on the availability and/or interruptability associated with one or more entities. The recommendations may be ranked based on one or more suitable techniques for quantifying the eligibility of a provider or a customer, a priority with respect to an event, and other criteria defined in contextual data received by the system 100.

In some configurations a recommended date and time, e.g., a timeslot, can be based on the availability of one or more parties involved, such as a provider or a customer. The date and time of the recommendation can also be based on location information, map data and other information that enables the customer and/or the provider to successfully commute to an appointment. As will be described in more detail below, the use of preference data and other data can be used to identify and/or rank a recommended timeslot. In addition to generating recommendations for a timeslot, the techniques disclosed herein can also include the selection of one or more providers.

The selection and/or ranking of a candidate providers and/or candidate timeslots can be based on a number of factors. In some configurations, the analysis of scheduling data 131 can influence a selection or ranking of one or more providers. For instance, the techniques disclosed herein can identify one or more providers that is available at a date and time indicated in the input data. If one or more providers are available during the desired date and time, such providers may be selected and/or ranked in the ranked list of providers. A provider having an open schedule may be ranked higher than a provider having a conflict.

In addition, a severity of a conflict may influence the ranking of a candidate provider and/or candidate timeslot. In some configurations, the techniques disclosed herein can cause the generation of data indicating a severity of a conflict. Such a quantification can be based on a number of factors, including scheduling data of two or more entities, a probability of a commute between two or more appointments, and other factors that can be used to determine that a meeting is improbable or probable. Data indicating a severity of a conflict can also be based on factors indicating that scheduling conflict is irreconcilable or reconcilable. Data indicating a severity of a conflict can also be based on a priority or a degree of interruptability with respect to a particular calendar event. For instance, if two meetings are determined to have a high degree of interruptability, a severity of such a conflict can be higher than a conflict where only one calendar event has a high degree of interruptability. When two or more calendar events present a conflict, the calendar event associated with a low degree of interruptability can be selected over a calendar event having a high degree of interruptability.

In one example, scheduling data 131 associated with one or more providers 105 and customers 103 can be analyzed to determine if there are scheduling conflicts. The ranking of a candidate provider and/or candidate timeslot can also be influenced by a severity of a scheduling conflict. For instance, if a first provider has a scheduling conflict that completely overlaps with an appointment defined by the input data, the ranking of the first provider may be lower than another provider having a scheduling conflict that does not completely overlap with the appointment defined by the input data. A candidate provider and/or candidate timeslot that is associated with a highly severe conflict can be ranked lower than a candidate provider and/or candidate timeslot associated with a less severe conflict.

In some configurations, a conflict or a condition associated with a calendar event may be based on an alignment between specialty data, skill set data, and other data associated with the calendar event. For instance, if a calendar event indicates a need for a dishwasher repair expert, and skill set data associated with a selected provider indicates that the provider's skill set does not align with a described task or need, the system 100 may detect a conflict, e.g., a presence of a condition that requires an action. The severity of a conflict can also be based on values quantifying an alignment between the skill set data and requirements associated with a calendar event. For example, if a calendar event indicates a need for an ear, nose and throat specialist, and the calendar event indicates an appointment with a general practitioner, one or more values may be generated to quantify this alignment, values which may be a factor in determining a severity of a conflict. The ranking of a recommended provider and/or a recommended timeslot can be adjusted based on data defining the severity of the conflict.

In some configurations, the analysis of location data 125, map data 127, weather data 136, and/or traffic data 124 can influence a selection and/or ranking of a candidate provider and/or candidate timeslot. For instance, a first provider may be ranked higher than a second provider if the first provider involves a shorter commute versus the second provider. Such an analysis may also involve map data, weather data, and other data to determine projections of commute times, a probability of a commute, and/or a degree of difficulty of a commute.

In some configurations, the analysis of location data 125 and scheduling data 131 can influence a selection and/or ranking of a candidate provider and/or candidate timeslot. For instance, if a particular provider has two calendar events that are adjacent to one another, a probability of a successful commute between the events can be determined. A provider having a high probability of a successful commute can be ranked higher than a provider having a low probability of a successful commute.

Such an analysis can apply to the commute of the customer. For instance, if a consumer has two appointments that are adjacent to one another, a probability associated with the consumer's commute between the appointments can influence the selection and/or ranking of one or more providers. For example, if the user scheduling data 131 indicates that the consumer only has 20 minutes to commute to the location of a particular provider, the map data 127, traffic data 124, and other contextual data can be analyzed to determine if that commute is possible within the given timeframe. A probability may be generated for a commute to each provider, and each provider may be ranked based on such generated data. In addition, one or more providers may be filtered from the list if the probability does not meet or exceed one or more thresholdsf.

The ranked list of recommendations can also be based on the map data 127, traffic data 124, location data 125, weather data 136 and/or other data. In such configurations, traffic data 124 can indicate traffic conditions at the desired date and time indicated in the input data. In such configurations, one or more devices and/or the server 120 can generate projections to determine if a user or provider can make an appointment based on traffic patterns. For instance, if the appointment is scheduled for a weekday during rush hour, the techniques disclosed herein can change the ranking of a particular provider if a commute associated with that provider is impacted by such traffic conditions. Such an analysis can be influenced by a forecast defined in weather data 136. For example, if weather data 136 indicates a favorable forecast, the ranking of providers impacted by such a forecast can increase. In addition, if weather data 136 indicates an unfavorable forecast, the ranking of providers impacted by such a forecast can decrease.

In some configurations, the analysis of work history data 133, skill set data 135, workflow data 128, workload data 132 and/or other contextual data can influence a selection and/or ranking of a candidate provider and/or candidate timeslot. For instance, a particular provider having a high quality rating may be ranked higher than a provider having a low quality rating. In another example, the skill set 135 can be analyzed to determine if an ability of a provider aligns with goals associated with a particular appointment. Data quantifying an alignment between the skill set of a provider with one or more goals can influence the ranking of that provider and/or other providers.

In another example, a provider having a heavier workload can be ranked higher or lower than a provider having a lighter workload. In yet another example, workflow data 128 can be analyzed to determine the ranking of a particular provider. For instance, workflow data 128 defining a multistep process indicates that a particular provider is more suitable for a particular step, the ranking of such a provider maybe higher than a provider that is less suitable for that particular step. These examples are provided for illustrative purposes and are not to be construed as limiting.

In some configurations, work history data 133 can define the status of a relationship between two or more entities. For instance, if two or more entities are currently working on a project, a ranking with respect to a customer and/or a provider may be increased. If the two or more parties have not worked together for some time, a ranking with respect to a customer and or a provider may be increased or decreased depending on a desired outcome. For instance, if a customer having a high lifetime value, such as Bill Gates' family, desires to set an appointment with a provider, such providers seeking such customers/patients may be ranked higher than other providers. In another example, if preference data of a patient indicates a desire to work with a doctor or other provider having a certain status, e.g., a top 10 specialist, such providers matching customer goals can be ranked higher than other providers that do not match the goals.

In some configurations, a ranking and/or selection of a provider can be based on payment history data. For example, if payments of a customer are regularly made on time, the ranking of a provider desiring such customers may be increased. In some configurations, preference data may define a threshold for a provider. If performance data associated with a customer falls below a threshold, e.g., with respect to payments, communication, and/or complaints, the techniques disclosed herein can cause the generation of data providing notice that a customer relationship should be terminated. Other data providing notice of reminders can be generated in response to one more conditions, such as a late payment, a history of late payments, complaints, etc. In such configurations, emails, meeting notifications or other forms of data objects can be generated when such conditions are discovered by the system.

The ranking and/or selection of a provider or a customer can be influenced by a number of factors. It can be appreciated that any suitable form of contextual data can also influence the ranking and/or selection of an entity. For instance, if status data indicates an entity is available or unavailable, a ranking or selection of an entity associated with such a status can be influenced, e.g., raised or lowered.

It can also be appreciated that a level of eligibility can be based on a collection or combination of values determined by individual factors. For instance, if scheduling data indicates a high ranking for a provider or customer, and one or more attributes of work history data indicate a low ranking for the provider or the customer, a level of eligibility can be based on a combination of such rankings, each of which may be weighted. A weighting of one or more values may be influenced by preference data or other data.

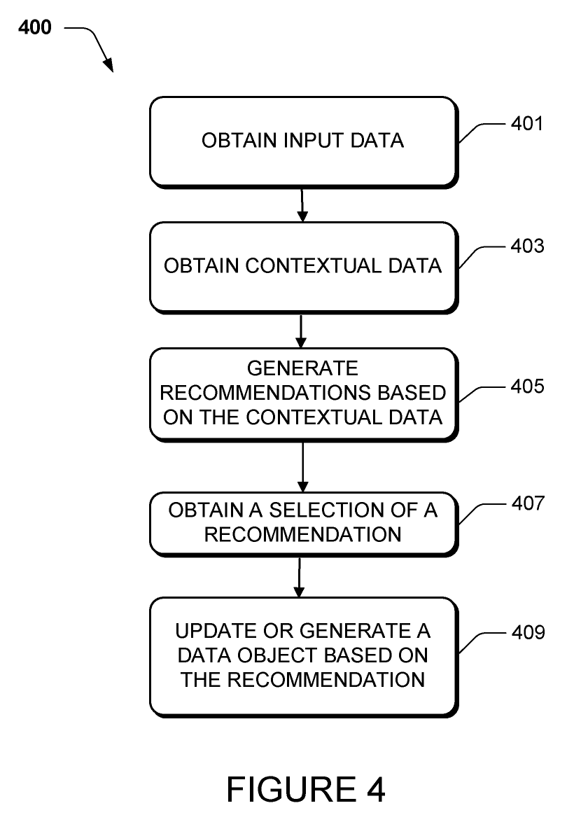

Turning now to FIG. 4, aspects of a routine 400 for providing a contextually-aware resource manager are shown and described below. It should be understood that the operations of the methods disclosed herein are not necessarily presented in any particular order and that performance of some or all of the operations in an alternative order(s) is possible and is contemplated. The operations have been presented in the demonstrated order for ease of description and illustration. Operations may be added, omitted, and/or performed simultaneously, without departing from the scope of the appended claims.

It also should be understood that the illustrated methods can be ended at any time and need not be performed in its entirety. Some or all operations of the methods, and/or substantially equivalent operations, can be performed by execution of computer-readable instructions included on a computer-storage media, as defined below. The term “computer-readable instructions,” and variants thereof, as used in the description and claims, is used expansively herein to include routines, applications, application modules, program modules, programs, components, data structures, algorithms, and the like. Computer-readable instructions can be implemented on various system configurations, including single-processor or multiprocessor systems, minicomputers, mainframe computers, personal computers, hand-held computing devices, microprocessor-based, programmable consumer electronics, combinations thereof, and the like.

Thus, it should be appreciated that the logical operations described herein are implemented (1) as a sequence of computer implemented acts or program modules running on a computing system and/or (2) as interconnected machine logic circuits or circuit modules within the computing system. The implementation is a matter of choice dependent on the performance and other requirements of the computing system. Accordingly, the logical operations described herein are referred to variously as states, operations, structural devices, acts, or modules. These operations, structural devices, acts, and modules may be implemented in software, in firmware, in special purpose digital logic, and any combination thereof.

As will be described in more detail below, in conjunction with FIG. 1, the operations of the routine 400 are described herein as being implemented, at least in part, by an application, component, and/or circuit. Although the following illustration refers to the components of FIG. 1, it can be appreciated that the operations of the routine 400 may be also implemented in many other ways. For example, the routine 400 may be implemented, at least in part, by computer processor or processor of another computer. In addition, one or more of the operations of the routine 400 may alternatively or additionally be implemented, at least in part, by a computer working alone or in conjunction with other software modules, such as the server module 121.

With reference to FIG. 4, the routine 400 begins at operation 401, where one or more computing devices obtain input data. The input data can include a voice input, a text input, a selection of a menu item, or other types of input where an action is initiated by, or data is received from, a user or a computing device. For example, a user can say or type information into an email or a calendar event describing a topic, area of interest, project or an event. In other examples, a user can provide other forms of input data, such as a text description or a voice input indicating a service category, e.g., “I need to schedule an appointment to fix my car,” or “I need to make an appointment for my team.” As also described herein, the input data can include scheduling data 131 and any other suitable data.

Next, in operation 403, the one or more computing devices obtain contextual data. As described herein, the contextual data can be obtained from a number of different resources. For example, contextual data can be obtained from a traffic data resource 106A, map data resource 106B, search engine resource 106C, specialty data resource 106D, and a weather data resource 106E, and/or other resources suitable for storing, processing, and/or communicating contextual data.

The contextual data can be related to service providers and/or consumers. The contextual can include, for example, data defining a prior work history between two or more entities, payment histories, credit histories, an availability of one or more parties, a location of a project, travel time to an appointment, traffic data, skill set data, preferred business hours, scheduling availability, performance metrics, scheduling conflicts, customer preferences, vendor preferences, workflow definitions, other data, and combinations thereof. The techniques disclosed herein can also quantify a value of a customer or a value of a vendor. Such contextual data can be received from one or more resources or such contextual data can be derived from other types of contextual data. For instance, data defining a lifetime value of a customer or a lifetime value of a provider can be generated from payment histories, credit histories, and other information.

Operation 403 can also include the collection of specialty data 126 and skill set data 135 pertaining to a specialization, subject, topic, one or more industries, or an area of interest. For example, the specialty data 126 and skill set data 135 can associate a number of providers with particular skill sets. Such data can be stored in a database to enable a system to identify one or more providers associated with a particular skill set or a service category. In addition, the database can be configured to identify one or more skill sets or service categories based on the name or other identifying information to a provider.

Next, in operation 405, one or more computing devices can generate one or more recommendations. As described herein, a recommendation may include a timeslot, a provider, a customer, and/or other information that is based on an analysis of the contextual data. In some configurations, one or more computing devices can generate a ranked list of items, e.g., a ranked list of recommendations.

The recommendations can be automatically generated based on the presence of a condition, or the recommendations can be generated in response to one or more user-initiated actions. In one example, criteria defined in user preference data can indicate one or more thresholds for generating a ranked list of items. The contextual data can be analyzed to determine the presence of a condition that meets or exceeds the one or more thresholds. When such conditions are discovered, one or more computing devices can generate one or more recommendations.

In another example, one or more recommendations can be generated in response to a user-initiated action. For example, when a user provides input data defining a calendar item, the input data and the contextual data can be processed by the use of the techniques described herein to generate a ranked list of items, e.g., a ranked list of recommendations. It can be appreciated that a ranked list of recommendations can also include tasks, such as a reminder to schedule an appointment, email message, text a party, or generate any other data object related to the workflow data. Examples of several recommendations are shown in FIG. 3A and FIG. 3B. Although the examples illustrate configurations providing a number of recommendations, it can be appreciated that a single recommendation can be displayed on a graphical user interface.

Next, in operation 407, one or more computing devices can obtain a selection of a recommendation. The selection of a recommendation can be in response to receiving data defining a selection, such as a user input indicating a selection, or the selection of a recommendation can involve an automated process. In configurations involving an automated process, a selection can be based, at least in part, on criteria, which can be defined in the preference data. In such configurations, if the contextual data indicates that a particular timeslot and/or a provider may meet one or more criteria, one or more computing devices can automatically select a suitable recommendation.

In some configurations, one or more computing devices can display a ranked list of recommendations. The ranked list may be displayed in proximity to a graphical element of a graphical user interface to receive input data. For example, as shown in FIG. 3A and FIG. 3B, a graphical element displaying the ranked list can in proximity to a recipient UI element, date UI element, or a time UI element.

Next, at operation 413, one or more computing devices can update and/or generate a data object based on the selected recommendation. Among many examples, one or more computing devices can modify a calendar event to mitigate or eliminate a conflict. Modifications can include a new date or time, a new provider, or other modifications that mitigate the presence of a condition or conflict. The generation of new calendar events may also include the recommended time and/or recommended providers or customers. In other examples, a data object may include reminders, notifications, emails, and other data objects related to a generated recommendation.

FIG. 5 shows additional details of an example computer architecture 500 for a computer, such as the computing device 101 (FIG. 1), capable of executing the program components described herein. Thus, the computer architecture 500 illustrated in FIG. 5 illustrates an architecture for a server computer, mobile phone, a PDA, a smart phone, a desktop computer, a netbook computer, a tablet computer, and/or a laptop computer. The computer architecture 500 may be utilized to execute any aspects of the software components presented herein.

The computer architecture 500 illustrated in FIG. 5 includes a central processing unit 502 (“CPU”), a system memory 504, including a random access memory 506 (“RAM”) and a read-only memory (“ROM”) 508, and a system bus 510 that couples the memory 504 to the CPU 502. A basic input/output system containing the basic routines that help to transfer information between elements within the computer architecture 500, such as during startup, is stored in the ROM 508. The computer architecture 500 further includes a mass storage device 512 for storing an operating system 507 and other data, such as the contextual data 550 and input data 551.

The mass storage device 512 is connected to the CPU 502 through a mass storage controller (not shown) connected to the bus 510. The mass storage device 512 and its associated computer-readable media provide non-volatile storage for the computer architecture 500. Although the description of computer-readable media contained herein refers to a mass storage device, such as a solid state drive, a hard disk or CD-ROM drive, it should be appreciated by those skilled in the art that computer-readable media can be any available computer storage media or communication media that can be accessed by the computer architecture 500.

Communication media includes computer readable instructions, data structures, program modules, or other data in a modulated data signal such as a carrier wave or other transport mechanism and includes any delivery media. The term “modulated data signal” means a signal that has one or more of its characteristics changed or set in a manner as to encode information in the signal. By way of example, and not limitation, communication media includes wired media such as a wired network or direct-wired connection, and wireless media such as acoustic, RF, infrared and other wireless media. Combinations of the any of the above should also be included within the scope of computer-readable media.

By way of example, and not limitation, computer storage media may include volatile and non-volatile, removable and non-removable media implemented in any method or technology for storage of information such as computer-readable instructions, data structures, program modules or other data. For example, computer media includes, but is not limited to, RAM, ROM, EPROM, EEPROM, flash memory or other solid state memory technology, CD-ROM, digital versatile disks (“DVD”), HD-DVD, BLU-RAY, or other optical storage, magnetic cassettes, magnetic tape, magnetic disk storage or other magnetic storage devices, or any other medium which can be used to store the desired information and which can be accessed by the computer architecture 500. For purposes the claims, the phrase “computer storage medium,” “computer-readable storage medium” and variations thereof, does not include waves, signals, and/or other transitory and/or intangible communication media, per se.

According to various configurations, the computer architecture 500 may operate in a networked environment using logical connections to remote computers through the network 756 and/or another network (not shown). The computer architecture 500 may connect to the network 756 through a network interface unit 514 connected to the bus 510. It should be appreciated that the network interface unit 514 also may be utilized to connect to other types of networks and remote computer systems. The computer architecture 500 also may include an input/output controller 516 for receiving and processing input from a number of other devices, including a keyboard, mouse, or electronic stylus (not shown in FIG. 5). Similarly, the input/output controller 516 may provide output to a display screen, a printer, or other type of output device (also not shown in FIG. 5).

It should be appreciated that the software components described herein may, when loaded into the CPU 502 and executed, transform the CPU 502 and the overall computer architecture 500 from a general-purpose computing system into a special-purpose computing system customized to facilitate the functionality presented herein. The CPU 502 may be constructed from any number of transistors or other discrete circuit elements, which may individually or collectively assume any number of states. More specifically, the CPU 502 may operate as a finite-state machine, in response to executable instructions contained within the software modules disclosed herein. These computer-executable instructions may transform the CPU 502 by specifying how the CPU 502 transitions between states, thereby transforming the transistors or other discrete hardware elements constituting the CPU 502.

Encoding the software modules presented herein also may transform the physical structure of the computer-readable media presented herein. The specific transformation of physical structure may depend on various factors, in different implementations of this description. Examples of such factors may include, but are not limited to, the technology used to implement the computer-readable media, whether the computer-readable media is characterized as primary or secondary storage, and the like. For example, if the computer-readable media is implemented as semiconductor-based memory, the software disclosed herein may be encoded on the computer-readable media by transforming the physical state of the semiconductor memory. For example, the software may transform the state of transistors, capacitors, or other discrete circuit elements constituting the semiconductor memory. The software also may transform the physical state of such components in order to store data thereupon.

As another example, the computer-readable media disclosed herein may be implemented using magnetic or optical technology. In such implementations, the software presented herein may transform the physical state of magnetic or optical media, when the software is encoded therein. These transformations may include altering the magnetic characteristics of particular locations within given magnetic media. These transformations also may include altering the physical features or characteristics of particular locations within given optical media, to change the optical characteristics of those locations. Other transformations of physical media are possible without departing from the scope and spirit of the present description, with the foregoing examples provided only to facilitate this discussion.

In light of the above, it should be appreciated that many types of physical transformations take place in the computer architecture 500 in order to store and execute the software components presented herein. It also should be appreciated that the computer architecture 500 may include other types of computing devices, including hand-held computers, embedded computer systems, personal digital assistants, and other types of computing devices known to those skilled in the art. It is also contemplated that the computer architecture 500 may not include all of the components shown in FIG. 5, may include other components that are not explicitly shown in FIG. 5, or may utilize an architecture completely different than that shown in FIG. 5.

FIG. 6 depicts an illustrative distributed computing environment 600 capable of executing the software components described herein for providing a contextually-aware resource manager. Thus, the distributed computing environment 600 illustrated in FIG. 6 can be utilized to execute any aspects of the software components presented herein. For example, the distributed computing environment 600 can be utilized to execute aspects of the software components described herein.

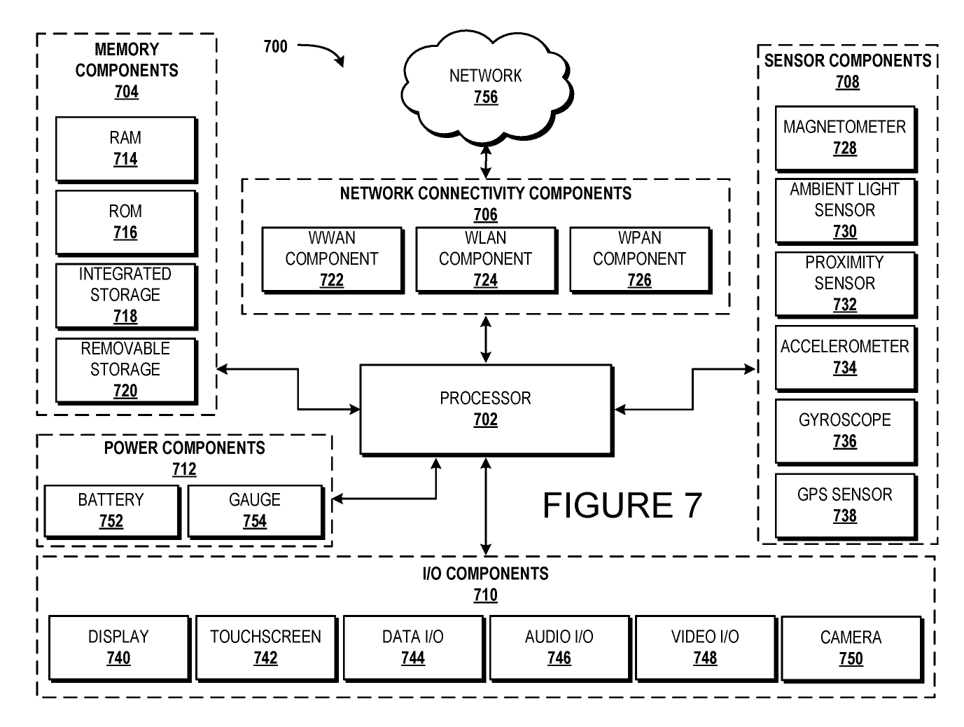

According to various implementations, the distributed computing environment 600 includes a computing environment 602 operating on, in communication with, or as part of the network 604. The network 604 may be or may include the network 756, described above with reference to FIG. 5. The network 604 also can include various access networks. One or more client devices 606A-606N (hereinafter referred to collectively and/or generically as “clients 606”) can communicate with the computing environment 602 via the network 604 and/or other connections (not illustrated in FIG. 6). In one illustrated configuration, the clients 606 include a computing device 606A such as a laptop computer, a desktop computer, or other computing device; a slate or tablet computing device (“tablet computing device”) 606B; a mobile computing device 606C such as a mobile telephone, a smart phone, or other mobile computing device; a server computer 606D; and/or other devices 606N. It should be understood that any number of clients 606 can communicate with the computing environment 602. Two example computing architectures for the clients 606 are illustrated and described herein with reference to FIGS. 5 and 7. It should be understood that the illustrated clients 606 and computing architectures illustrated and described herein are illustrative, and should not be construed as being limited in any way.

In the illustrated configuration, the computing environment 602 includes application servers 608, data storage 610, and one or more network interfaces 612. According to various implementations, the functionality of the application servers 608 can be provided by one or more server computers that are executing as part of, or in communication with, the network 604. The application servers 608 can host various services, virtual machines, portals, and/or other resources. In the illustrated configuration, the application servers 608 host one or more virtual machines 614 for hosting applications or other functionality. According to various implementations, the virtual machines 614 host one or more applications and/or software modules for providing a contextually-aware resource manager. It should be understood that this configuration is illustrative, and should not be construed as being limiting in any way. The application servers 608 also host or provide access to one or more portals, link pages, Web sites, and/or other information (“Web portals”) 616.

According to various implementations, the application servers 608 also include one or more mailbox services 618 and one or more messaging services 620. The mailbox services 618 can include electronic mail (“email”) services. The mailbox services 618 also can include various personal information management (“PIM”) services including, but not limited to, calendar services, contact management services, collaboration services, and/or other services. The messaging services 620 can include, but are not limited to, instant messaging services, chat services, forum services, and/or other communication services.

The application servers 608 also may include one or more social networking services 622. The social networking services 622 can include various social networking services including, but not limited to, services for sharing or posting status updates, instant messages, links, photos, videos, and/or other information; services for commenting or displaying interest in articles, products, blogs, or other resources; and/or other services. In some configurations, the social networking services 622 are provided by or include the FACEBOOK social networking service, the LINKEDIN professional networking service, the MYSPACE social networking service, the FOURSQUARE geographic networking service, the YAMMER office colleague networking service, and the like. In other configurations, the social networking services 622 are provided by other services, sites, and/or providers that may or may not be explicitly known as social networking providers. For example, some web sites allow users to interact with one another via email, chat services, and/or other means during various activities and/or contexts such as reading published articles, commenting on goods or services, publishing, collaboration, gaming, and the like. Examples of such services include, but are not limited to, the WINDOWS LIVE service and the XBOX LIVE service from Microsoft Corporation in Redmond, Wash. Other services are possible and are contemplated.

The social networking services 622 also can include commenting, blogging, and/or micro blogging services. Examples of such services include, but are not limited to, the YELP commenting service, the KUDZU review service, the OFFICETALK enterprise micro blogging service, the TWITTER messaging service, the GOOGLE BUZZ service, and/or other services. It should be appreciated that the above lists of services are not exhaustive and that numerous additional and/or alternative social networking services 622 are not mentioned herein for the sake of brevity. As such, the above configurations are illustrative, and should not be construed as being limited in any way. According to various implementations, the social networking services 622 may host one or more applications and/or software modules for providing the functionality described herein for providing a contextually-aware resource manager. For instance, any one of the application servers 608 may communicate or facilitate the functionality and features described herein. For instance, a social networking application, mail client, messaging client or a browser running on a phone or any other client 606 may communicate with a networking service 622 and facilitate the functionality, even in part, described above with respect to FIG. 4.

As shown in FIG. 6, the application servers 608 also can host other services, applications, portals, and/or other resources (“other resources”) 624. The other resources 624 can include, but are not limited to, document sharing, rendering or any other functionality. It thus can be appreciated that the computing environment 602 can provide integration of the concepts and technologies disclosed herein provided herein with various mailbox, messaging, social networking, and/or other services or resources.

As mentioned above, the computing environment 602 can include the data storage 610. According to various implementations, the functionality of the data storage 610 is provided by one or more databases operating on, or in communication with, the network 604. The functionality of the data storage 610 also can be provided by one or more server computers configured to host data for the computing environment 602. The data storage 610 can include, host, or provide one or more real or virtual datastores 626A-626N (hereinafter referred to collectively and/or generically as “datastores 626”). The datastores 626 are configured to host data used or created by the application servers 608 and/or other data. Although not illustrated in FIG. 6, the datastores 626 also can host or store web page documents, word documents, presentation documents, data structures, algorithms for execution by a recommendation engine, and/or other data utilized by any application program or another module. Aspects of the datastores 626 may be associated with a service for storing files.

The computing environment 602 can communicate with, or be accessed by, the network interfaces 612. The network interfaces 612 can include various types of network hardware and software for supporting communications between two or more computing devices including, but not limited to, the clients 606 and the application servers 608. It should be appreciated that the network interfaces 612 also may be utilized to connect to other types of networks and/or computer systems.

It should be understood that the distributed computing environment 600 described herein can provide any aspects of the software elements described herein with any number of virtual computing resources and/or other distributed computing functionality that can be configured to execute any aspects of the software components disclosed herein. According to various implementations of the concepts and technologies disclosed herein, the distributed computing environment 600 provides the software functionality described herein as a service to the clients 606. It should be understood that the clients 606 can include real or virtual machines including, but not limited to, server computers, web servers, personal computers, mobile computing devices, smart phones, and/or other devices. As such, various configurations of the concepts and technologies disclosed herein enable any device configured to access the distributed computing environment 600 to utilize the functionality described herein for providing a contextually-aware resource manager, among other aspects.

Turning now to FIG. 7, an illustrative computing device architecture 700 for a computing device that is capable of executing various software components described herein for providing a contextually-aware resource manager. The computing device architecture 700 is applicable to computing devices that facilitate mobile computing due, in part, to form factor, wireless connectivity, and/or battery-powered operation. In some configurations, the computing devices include, but are not limited to, mobile telephones, tablet devices, slate devices, portable video game devices, and the like. The computing device architecture 700 is applicable to any of the clients 606 shown in FIG. 6. Moreover, aspects of the computing device architecture 700 may be applicable to traditional desktop computers, portable computers (e.g., laptops, notebooks, ultra-portables, and netbooks), server computers, and other computer systems, such as described herein with reference to FIG. 5. For example, the single touch and multi-touch aspects disclosed herein below may be applied to desktop computers that utilize a touchscreen or some other touch-enabled device, such as a touch-enabled track pad or touch-enabled mouse.

The computing device architecture 700 illustrated in FIG. 7 includes a processor 702, memory components 704, network connectivity components 706, sensor components 708, input/output components 710, and power components 712. In the illustrated configuration, the processor 702 is in communication with the memory components 704, the network connectivity components 706, the sensor components 708, the input/output (“I/O”) components 710, and the power components 712. Although no connections are shown between the individuals components illustrated in FIG. 7, the components can interact to carry out device functions. In some configurations, the components are arranged so as to communicate via one or more busses (not shown).

The processor 702 includes a central processing unit (“CPU”) configured to process data, execute computer-executable instructions of one or more application programs, and communicate with other components of the computing device architecture 700 in order to perform various functionality described herein. The processor 702 may be utilized to execute aspects of the software components presented herein and, particularly, those that utilize, at least in part, a touch-enabled input.

In some configurations, the processor 702 includes a graphics processing unit (“GPU”) configured to accelerate operations performed by the CPU, including, but not limited to, operations performed by executing general-purpose scientific and/or engineering computing applications, as well as graphics-intensive computing applications such as high resolution video (e.g., 720P, 1080P, and higher resolution), video games, three-dimensional (“3D”) modeling applications, and the like. In some configurations, the processor 702 is configured to communicate with a discrete GPU (not shown). In any case, the CPU and GPU may be configured in accordance with a co-processing CPU/GPU computing model, wherein the sequential part of an application executes on the CPU and the computationally-intensive part is accelerated by the GPU.

In some configurations, the processor 702 is, or is included in, a system-on-chip (“SoC”) along with one or more of the other components described herein below. For example, the SoC may include the processor 702, a GPU, one or more of the network connectivity components 706, and one or more of the sensor components 708. In some configurations, the processor 702 is fabricated, in part, utilizing a package-on-package (“PoP”) integrated circuit packaging technique. The processor 702 may be a single core or multi-core processor.

The processor 702 may be created in accordance with an ARM architecture, available for license from ARM HOLDINGS of Cambridge, United Kingdom. Alternatively, the processor 702 may be created in accordance with an x86 architecture, such as is available from INTEL CORPORATION of Mountain View, Calif. and others. In some configurations, the processor 702 is a SNAPDRAGON SoC, available from QUALCOMM of San Diego, Calif., a TEGRA SoC, available from NVIDIA of Santa Clara, Calif., a HUMMINGBIRD SoC, available from SAMSUNG of Seoul, South Korea, an Open Multimedia Application Platform (“OMAP”) SoC, available from TEXAS INSTRUMENTS of Dallas, Tex., a customized version of any of the above SoCs, or a proprietary SoC.

The memory components 704 include a random access memory (“RAM”) 714, a read-only memory (“ROM”) 716, an integrated storage memory (“integrated storage”) 718, and a removable storage memory (“removable storage”) 720. In some configurations, the RAM 714 or a portion thereof, the ROM 716 or a portion thereof, and/or some combination the RAM 714 and the ROM 716 is integrated in the processor 702. In some configurations, the ROM 716 is configured to store a firmware, an operating system or a portion thereof (e.g., operating system kernel), and/or a bootloader to load an operating system kernel from the integrated storage 718 and/or the removable storage 720.

The integrated storage 718 can include a solid-state memory, a hard disk, or a combination of solid-state memory and a hard disk. The integrated storage 718 may be soldered or otherwise connected to a logic board upon which the processor 702 and other components described herein also may be connected. As such, the integrated storage 718 is integrated in the computing device. The integrated storage 718 is configured to store an operating system or portions thereof, application programs, data, and other software components described herein.

The removable storage 720 can include a solid-state memory, a hard disk, or a combination of solid-state memory and a hard disk. In some configurations, the removable storage 720 is provided in lieu of the integrated storage 718. In other configurations, the removable storage 720 is provided as additional optional storage. In some configurations, the removable storage 720 is logically combined with the integrated storage 718 such that the total available storage is made available as a total combined storage capacity. In some configurations, the total combined capacity of the integrated storage 718 and the removable storage 720 is shown to a user instead of separate storage capacities for the integrated storage 718 and the removable storage 720.

The removable storage 720 is configured to be inserted into a removable storage memory slot (not shown) or other mechanism by which the removable storage 720 is inserted and secured to facilitate a connection over which the removable storage 720 can communicate with other components of the computing device, such as the processor 702. The removable storage 720 may be embodied in various memory card formats including, but not limited to, PC card, CompactFlash card, memory stick, secure digital (“SD”), miniSD, microSD, universal integrated circuit card (“UICC”) (e.g., a subscriber identity module (“SIM”) or universal SIM (“USIM”)), a proprietary format, or the like.

It can be understood that one or more of the memory components 704 can store an operating system. According to various configurations, the operating system includes, but is not limited to WINDOWS MOBILE OS from Microsoft Corporation of Redmond, Wash., WINDOWS PHONE OS from Microsoft Corporation, WINDOWS from Microsoft Corporation, PALM WEBOS from Hewlett-Packard Company of Palo Alto, Calif., BLACKBERRY OS from Research In Motion Limited of Waterloo, Ontario, Canada, IOS from Apple Inc. of Cupertino, Calif., and ANDROID OS from Google Inc. of Mountain View, Calif. Other operating systems are contemplated.

The network connectivity components 706 include a wireless wide area network component (“WWAN component”) 722, a wireless local area network component (“WLAN component”) 724, and a wireless personal area network component (“WPAN component”) 726. The network connectivity components 706 facilitate communications to and from the network 756 or another network, which may be a WWAN, a WLAN, or a WPAN. Although only the network 756 is illustrated, the network connectivity components 706 may facilitate simultaneous communication with multiple networks, including the network 604 of FIG. 6. For example, the network connectivity components 706 may facilitate simultaneous communications with multiple networks via one or more of a WWAN, a WLAN, or a WPAN.

The network 756 may be or may include a WWAN, such as a mobile telecommunications network utilizing one or more mobile telecommunications technologies to provide voice and/or data services to a computing device utilizing the computing device architecture 700 via the WWAN component 722. The mobile telecommunications technologies can include, but are not limited to, Global System for Mobile communications (“GSM”), Code Division Multiple Access (“CDMA”) ONE, CDMA7000, Universal Mobile Telecommunications System (“UMTS”), Long Term Evolution (“LTE”), and Worldwide Interoperability for Microwave Access (“WiMAX”). Moreover, the network 756 may utilize various channel access methods (which may or may not be used by the aforementioned standards) including, but not limited to, Time Division Multiple Access (“TDMA”), Frequency Division Multiple Access (“FDMA”), CDMA, wideband CDMA (“W-CDMA”), Orthogonal Frequency Division Multiplexing (“OFDM”), Space Division Multiple Access (“SDMA”), and the like. Data communications may be provided using General Packet Radio Service (“GPRS”), Enhanced Data rates for Global Evolution (“EDGE”), the High-Speed Packet Access (“HSPA”) protocol family including High-Speed Downlink Packet Access (“HSDPA”), Enhanced Uplink (“EUL”) or otherwise termed High-Speed Uplink Packet Access (“HSUPA”), Evolved HSPA (“HSPA+”), LTE, and various other current and future wireless data access standards. The network 756 may be configured to provide voice and/or data communications with any combination of the above technologies. The network 756 may be configured to or adapted to provide voice and/or data communications in accordance with future generation technologies.

In some configurations, the WWAN component 722 is configured to provide dual-multi-mode connectivity to the network 756. For example, the WWAN component 722 may be configured to provide connectivity to the network 756, wherein the network 756 provides service via GSM and UMTS technologies, or via some other combination of technologies. Alternatively, multiple WWAN components 722 may be utilized to perform such functionality, and/or provide additional functionality to support other non-compatible technologies (i.e., incapable of being supported by a single WWAN component). The WWAN component 722 may facilitate similar connectivity to multiple networks (e.g., a UMTS network and an LTE network).

The network 756 may be a WLAN operating in accordance with one or more Institute of Electrical and Electronic Engineers (“IEEE”) 802.11 standards, such as IEEE 802.11a, 802.11b, 802.11g, 802.11n, and/or future 802.11 standard (referred to herein collectively as WI-FI). Draft 802.11 standards are also contemplated. In some configurations, the WLAN is implemented utilizing one or more wireless WI-FI access points. In some configurations, one or more of the wireless WI-FI access points are another computing device with connectivity to a WWAN that are functioning as a WI-FI hotspot. The WLAN component 724 is configured to connect to the network 756 via the WI-FI access points. Such connections may be secured via various encryption technologies including, but not limited, WI-FI Protected Access (“WPA”), WPA2, Wired Equivalent Privacy (“WEP”), and the like.

The network 756 may be a WPAN operating in accordance with Infrared Data Association (“IrDA”), BLUETOOTH, wireless Universal Serial Bus (“USB”), Z-Wave, ZIGBEE, or some other short-range wireless technology. In some configurations, the WPAN component 726 is configured to facilitate communications with other devices, such as peripherals, computers, or other computing devices via the WPAN.

The sensor components 708 include a magnetometer 728, an ambient light sensor 730, a proximity sensor 732, an accelerometer 734, a gyroscope 736, and a Global Positioning System sensor (“GPS sensor”) 738. It is contemplated that other sensors, such as, but not limited to, temperature sensors or shock detection sensors, also may be incorporated in the computing device architecture 700.

The magnetometer 728 is configured to measure the strength and direction of a magnetic field. In some configurations the magnetometer 728 provides measurements to a compass application program stored within one of the memory components 704 in order to provide a user with accurate directions in a frame of reference including the cardinal directions, north, south, east, and west. Similar measurements may be provided to a navigation application program that includes a compass component. Other uses of measurements obtained by the magnetometer 728 are contemplated.

The ambient light sensor 730 is configured to measure ambient light. In some configurations, the ambient light sensor 730 provides measurements to an application program stored within one the memory components 704 in order to automatically adjust the brightness of a display (described below) to compensate for low-light and high-light environments. Other uses of measurements obtained by the ambient light sensor 730 are contemplated.

The proximity sensor 732 is configured to detect the presence of an object or thing in proximity to the computing device without direct contact. In some configurations, the proximity sensor 732 detects the presence of a user's body (e.g., the user's face) and provides this information to an application program stored within one of the memory components 704 that utilizes the proximity information to enable or disable some functionality of the computing device. For example, a telephone application program may automatically disable a touchscreen (described below) in response to receiving the proximity information so that the user's face does not inadvertently end a call or enable/disable other functionality within the telephone application program during the call. Other uses of proximity as detected by the proximity sensor 732 are contemplated.

The accelerometer 734 is configured to measure proper acceleration. In some configurations, output from the accelerometer 734 is used by an application program as an input mechanism to control some functionality of the application program. For example, the application program may be a video game in which a character, a portion thereof, or an object is moved or otherwise manipulated in response to input received via the accelerometer 734. In some configurations, output from the accelerometer 734 is provided to an application program for use in switching between landscape and portrait modes, calculating coordinate acceleration, or detecting a fall. Other uses of the accelerometer 734 are contemplated.

The gyroscope 736 is configured to measure and maintain orientation. In some configurations, output from the gyroscope 736 is used by an application program as an input mechanism to control some functionality of the application program. For example, the gyroscope 736 can be used for accurate recognition of movement within a 3D environment of a video game application or some other application. In some configurations, an application program utilizes output from the gyroscope 736 and the accelerometer 734 to enhance control of some functionality of the application program. Other uses of the gyroscope 736 are contemplated.

The GPS sensor 738 is configured to receive signals from GPS satellites for use in calculating a location. The location calculated by the GPS sensor 738 may be used by any application program that requires or benefits from location information. For example, the location calculated by the GPS sensor 738 may be used with a navigation application program to provide directions from the location to a destination or directions from the destination to the location. Moreover, the GPS sensor 738 may be used to provide location information to an external location-based service, such as E911 service. The GPS sensor 738 may obtain location information generated via WI-FI, WIMAX, and/or cellular triangulation techniques utilizing one or more of the network connectivity components 706 to aid the GPS sensor 738 in obtaining a location fix. The GPS sensor 738 may also be used in Assisted GPS (“A-GPS”) systems.

The I/O components 710 include a display 740, a touchscreen 742, a data I/O interface component (“data I/O”) 744, an audio I/O interface component (“audio I/O”) 746, a video I/O interface component (“video I/O”) 748, and a camera 750. In some configurations, the display 740 and the touchscreen 742 are combined. In some configurations two or more of the data I/O component 744, the audio I/O component 746, and the video I/O component 748 are combined. The I/O components 710 may include discrete processors configured to support the various interface described below, or may include processing functionality built-in to the processor 702.

The display 740 is an output device configured to present information in a visual form. In particular, the display 740 may present graphical user interface (“GUI”) elements, text, images, video, notifications, virtual buttons, virtual keyboards, messaging data, Internet content, device status, time, date, calendar data, preferences, map information, location information, and any other information that is capable of being presented in a visual form. In some configurations, the display 740 is a liquid crystal display (“LCD”) utilizing any active or passive matrix technology and any backlighting technology (if used). In some configurations, the display 740 is an organic light emitting diode (“OLED”) display. Other display types are contemplated.

The touchscreen 742, also referred to herein as a “touch-enabled screen,” is an input device configured to detect the presence and location of a touch. The touchscreen 742 may be a resistive touchscreen, a capacitive touchscreen, a surface acoustic wave touchscreen, an infrared touchscreen, an optical imaging touchscreen, a dispersive signal touchscreen, an acoustic pulse recognition touchscreen, or may utilize any other touchscreen technology. In some configurations, the touchscreen 742 is incorporated on top of the display 740 as a transparent layer to enable a user to use one or more touches to interact with objects or other information presented on the display 740. In other configurations, the touchscreen 742 is a touch pad incorporated on a surface of the computing device that does not include the display 740. For example, the computing device may have a touchscreen incorporated on top of the display 740 and a touch pad on a surface opposite the display 740.

In some configurations, the touchscreen 742 is a single-touch touchscreen. In other configurations, the touchscreen 742 is a multi-touch touchscreen. In some configurations, the touchscreen 742 is configured to detect discrete touches, single touch gestures, and/or multi-touch gestures. These are collectively referred to herein as gestures for convenience. Several gestures will now be described. It should be understood that these gestures are illustrative and are not intended to limit the scope of the appended claims. Moreover, the described gestures, additional gestures, and/or alternative gestures may be implemented in software for use with the touchscreen 742. As such, a developer may create gestures that are specific to a particular application program.

In some configurations, the touchscreen 742 supports a tap gesture in which a user taps the touchscreen 742 once on an item presented on the display 740. The tap gesture may be used for various reasons including, but not limited to, opening or launching whatever the user taps. In some configurations, the touchscreen 742 supports a double tap gesture in which a user taps the touchscreen 742 twice on an item presented on the display 740. The double tap gesture may be used for various reasons including, but not limited to, zooming in or zooming out in stages. In some configurations, the touchscreen 742 supports a tap and hold gesture in which a user taps the touchscreen 742 and maintains contact for at least a pre-defined time. The tap and hold gesture may be used for various reasons including, but not limited to, opening a context-specific menu.

In some configurations, the touchscreen 742 supports a pan gesture in which a user places a finger on the touchscreen 742 and maintains contact with the touchscreen 742 while moving the finger on the touchscreen 742. The pan gesture may be used for various reasons including, but not limited to, moving through screens, images, or menus at a controlled rate. Multiple finger pan gestures are also contemplated. In some configurations, the touchscreen 742 supports a flick gesture in which a user swipes a finger in the direction the user wants the screen to move. The flick gesture may be used for various reasons including, but not limited to, scrolling horizontally or vertically through menus or pages. In some configurations, the touchscreen 742 supports a pinch and stretch gesture in which a user makes a pinching motion with two fingers (e.g., thumb and forefinger) on the touchscreen 742 or moves the two fingers apart. The pinch and stretch gesture may be used for various reasons including, but not limited to, zooming gradually in or out of a web site, map, or picture.

Although the above gestures have been described with reference to the use one or more fingers for performing the gestures, other appendages such as toes or objects such as styluses may be used to interact with the touchscreen 742. As such, the above gestures should be understood as being illustrative and should not be construed as being limiting in any way.

The data I/O interface component 744 is configured to facilitate input of data to the computing device and output of data from the computing device. In some configurations, the data I/O interface component 744 includes a connector configured to provide wired connectivity between the computing device and a computer system, for example, for synchronization operation purposes. The connector may be a proprietary connector or a standardized connector such as USB, micro-USB, mini-USB, or the like. In some configurations, the connector is a dock connector for docking the computing device with another device such as a docking station, audio device (e.g., a digital music player), or video device.

The audio I/O interface component 746 is configured to provide audio input and/or output capabilities to the computing device. In some configurations, the audio I/O interface component 746 includes a microphone configured to collect audio signals. In some configurations, the audio I/O interface component 746 includes a headphone jack configured to provide connectivity for headphones or other external speakers. In some configurations, the audio I/O interface component 746 includes a speaker for the output of audio signals. In some configurations, the audio I/O interface component 746 includes an optical audio cable out.

The video I/O interface component 748 is configured to provide video input and/or output capabilities to the computing device. In some configurations, the video I/O interface component 748 includes a video connector configured to receive video as input from another device (e.g., a video media player such as a DVD or BLURAY player) or send video as output to another device (e.g., a monitor, a television, or some other external display). In some configurations, the video I/O interface component 748 includes a High-Definition Multimedia Interface (“HDMI”), mini-HDMI, micro-HDMI, DisplayPort, or proprietary connector to input/output video content. In some configurations, the video I/O interface component 748 or portions thereof is combined with the audio I/O interface component 746 or portions thereof.

The camera 750 can be configured to capture still images and/or video. The camera 750 may utilize a charge coupled device (“CCD”) or a complementary metal oxide semiconductor (“CMOS”) image sensor to capture images. In some configurations, the camera 750 includes a flash to aid in taking pictures in low-light environments. Settings for the camera 750 may be implemented as hardware or software buttons.

Although not illustrated, one or more hardware buttons may also be included in the computing device architecture 700. The hardware buttons may be used for controlling some operational aspect of the computing device. The hardware buttons may be dedicated buttons or multi-use buttons. The hardware buttons may be mechanical or sensor-based.

The illustrated power components 712 include one or more batteries 752, which can be connected to a battery gauge 754. The batteries 752 may be rechargeable or disposable. Rechargeable battery types include, but are not limited to, lithium polymer, lithium ion, nickel cadmium, and nickel metal hydride. Each of the batteries 752 may be made of one or more cells.

The battery gauge 754 can be configured to measure battery parameters such as current, voltage, and temperature. In some configurations, the battery gauge 754 is configured to measure the effect of a battery's discharge rate, temperature, age and other factors to predict remaining life within a certain percentage of error. In some configurations, the battery gauge 754 provides measurements to an application program that is configured to utilize the measurements to present useful power management data to a user. Power management data may include one or more of a percentage of battery used, a percentage of battery remaining, a battery condition, a remaining time, a remaining capacity (e.g., in watt hours), a current draw, and a voltage.

The power components 712 may also include a power connector, which may be combined with one or more of the aforementioned I/O components 710. The power components 712 may interface with an external power system or charging equipment via an I/O component.

The disclosure presented herein may be considered in view of the following clauses.

Clause A: A system, comprising: a processor; and a memory in communication with the processor, the memory having computer-readable instructions stored thereupon that, when executed by the processor, cause the system to perform a method comprising, receiving scheduling data defining a calendar event; obtaining contextual data from a plurality of resources, the contextual data including at least one of scheduling data, workload data, work history data, payment data, weather data, map data, traffic data, or location data; identifying a pattern of the contextual data indicating a presence of a condition that affects the calendar event; and generating data defining a recommendation defining a data object configured to resolve the condition.

Clause B: The system of Clause A, wherein identifying the pattern of the contextual data indicating the presence of the condition that affects the calendar event comprises: generating a value indicating a severity of the condition; and identifying the pattern of the contextual data indicating the presence of the condition that affects the calendar event when the value meets or exceeds one or more criteria.

Clause C: The system of Clause B, wherein the value of the severity of the condition is based, at least in part, on a degree of overlap or a threshold amount of time between the calendar event and another calendar event.

Clause D: The system of Clause B, wherein the value of the severity of the condition is based, at least in part, on a time between the calendar event and another calendar event and a commute time associated with the calendar event.

In closing, although the various configurations have been described in language specific to structural features and/or methodological acts, it is to be understood that the subject matter defined in the appended representations is not necessarily limited to the specific features or acts described. Rather, the specific features and acts are disclosed as example forms of implementing the claimed subject matter.

What is claimed is:

1. A computer-implemented method comprising:
receiving, at a computing device, input data indicating a service category;
receiving, at the computing device, contextual data including at least one of traffic data, location data, map data, preference data, scheduling data, workload data, work history data, status data, skill set data, or weather data;
determining, at the computing device, a level of eligibility associated with individual providers of a plurality of providers based, at least in part, on the contextual data;
selecting at least one provider of the plurality of providers based, at least in part, on the level of eligibility;
generating at least one recommendation identifying the at least one provider; and
generating data for at least one data object based on the at least one recommendation.

2. The method of claim 1, wherein the method further comprises analyzing the skill set data to generate data defining a degree of alignment between a skillset associated with the at least one provider and the service category, and wherein the level of eligibility associated with the at least one provider is based, at least in part, on the data defining the degree of alignment between the skillset associated with the at least one provider and the service category.

3. The method of claim 1, wherein the method further comprises analyzing the preference data to generate data defining a degree of alignment between a performance metric defined in the preference data and a performance indicator defined in the work history data associated with the at least one provider, and wherein the level of eligibility associated with the at least one provider is based, at least in part, on the data defining the degree of alignment between the performance metric and the performance indicator.

4. The method of claim 1, wherein the method further comprises analyzing the scheduling data to generate data defining a severity of a scheduling conflict associated with the at least one provider, and wherein the level of eligibility associated with the at least one provider is based, at least in part, on the data defining the severity of the scheduling conflict.

5. The method of claim 4, wherein the severity of the scheduling conflict is based, at least in part, on the location data, the traffic data, the map data, or the weather data.

6. The method of claim 1, wherein the level of eligibility associated with the least one provider is determined by:
determining a first probability of a commute associated with the at least one provider;
determining a second probability of a commute associated with at least one other provider; and
determining the level of eligibility associated with the least one provider based, at least in part, on a comparison of the first probability and the second probability.

7. The method of claim 1, wherein the method further comprises analyzing the preference data to generate data defining a degree of alignment between a threshold defined in the preference data and a workload indicator defined in the workload data, the workload indicator associated with the at least one provider, and wherein the level of eligibility associated with the at least one provider is based, at least in part, on the data defining the degree of alignment between the threshold and the workload indicator.

8. The method of claim 1, wherein the method further comprises analyzing the workflow data to generate data defining a degree of alignment between the service category and a stage of the workflow data, and wherein the level of eligibility associated with the at least one provider is based, at least in part, on the data defining the degree of alignment between the service category and the stage of the workflow data.

9. A system, comprising:
a processor; and
a memory in communication with the processor, the memory having computer-readable instructions stored thereupon that, when executed by the processor, cause the processor to perform a method comprising
receiving input data indicating a service category;
receiving contextual data including at least one of traffic data, location data, specialty data, map data, preference data, payment data, scheduling data, workload data, work history data, status data, skill set data, or weather data;
determining a level of eligibility associated with individual providers of a plurality of providers based, at least in part, on the contextual data;
generating a ranked list of at least one recommendation identifying the at least one provider, wherein a ranking of the at least one recommendation is based, at least in part, on a level of eligibility associated with the at least one provider;
obtaining data indicating a selection of the at least one recommendation; and
generating data for at least one data object based on the at least one recommendation in response to the selection of the at least one recommendation.

10. The system of claim 9, wherein the method further comprises analyzing the skill set data to generate data defining a degree of alignment between a skillset associated with the at least one provider and the service category, and wherein the level of eligibility associated with the at least one provider is based, at least in part, on the data defining the degree of alignment between the skillset associated with the at least one provider and the service category.

11. The system of claim 9, wherein the method further comprises analyzing the preference data to generate data defining a degree of alignment between a performance metric defined in the preference data and a performance indicator defined in the work history data associated with the at least one provider, and wherein the level of eligibility associated with the at least one provider is based, at least in part, on the data defining the degree of alignment between the performance metric and the performance indicator.

12. The system of claim 9, wherein the method further comprises analyzing the scheduling data to generate data defining a severity of a scheduling conflict associated with the at least one provider, and wherein the level of eligibility associated with the at least one provider is based, at least in part, on the data defining the severity of the scheduling conflict.

13. The system of claim 12, wherein the severity of the scheduling conflict is based, at least in part, on the location data, the traffic data, the map data, or the weather data.

14. The system of claim 9, wherein the level of eligibility associated with the least one provider is determined by:
determining a first probability of a commute associated with the at least one provider;
determining a second probability of a commute associated with at least one other provider; and
determining the level of eligibility associated with the least one provider based, at least in part, on a comparison of the first probability and the second probability.

15. The system of claim 9, wherein the method further comprises analyzing the preference data to generate data defining a degree of alignment between a threshold defined in the preference data and a workload indicator defined in the workload data, the workload indicator associated with the at least one provider, and wherein the level of eligibility associated with the at least one provider is based, at least in part, on the data defining the degree of alignment between the threshold and the workload indicator.

16. The system of claim 9, wherein the method further comprises analyzing the workflow data to generate data defining a degree of alignment between the service category and a stage of the workflow data, and wherein the level of eligibility associated with the at least one provider is based, at least in part, on the data defining the degree of alignment between the service category and the stage of the workflow data.

17. The system of claim 9, wherein the data object comprises at least one of a message, a notification, and a calendar event.

18. A system, comprising:
a processor; and
a memory in communication with the processor, the memory having computer-readable instructions stored thereupon that, when executed by the processor, cause the processor to perform a method comprising
receiving input data defining aspects of a calendar event;
receiving contextual data including at least one of traffic data, location data, map data, preference data, payment data, scheduling data, workload data, work history data, status data, skill set data, or weather data;
determining a level of eligibility associated with individual customers of a plurality of customers based, at least in part, on the contextual data;
selecting at least one customer of the plurality of customers based, at least in part, on the level of eligibility;
generating at least one recommendation identifying the at least one customer; and
generating data for at least one data object based on the at least one recommendation, wherein the data object comprises at least one of a message, a notification, and a calendar event.

19. The system of claim 18, wherein the method further comprises analyzing the payment data to generate data defining a degree of alignment between a payment history associated with the at least one customer and one or more provider-defined preferences, and wherein the level of eligibility associated with the at least one customer is based, at least in part, on the data defining the degree of alignment between the payment history and the one or more provider-defined preferences.

20. The system of claim 18, wherein the method further comprises analyzing the work history data to generate data defining a customer rating associated with the at least one customer, and wherein the level of eligibility associated with the at least one customer is based, at least in part, on the data defining the customer rating associated with the at least one customer.

21. The system of claim 18, wherein the method further comprises analyzing the scheduling data to generate data defining a severity of a scheduling conflict associated with the at least one customer, and wherein the level of eligibility associated with the at least one customer is based, at least in part, on the data defining the severity of the scheduling conflict.

22. The system of claim 21, wherein the severity of the scheduling conflict is based, at least in part, on the location data, the traffic data, the map data, or the weather data.

23. The system of claim 18, wherein the level of eligibility associated with the least one customer is determined by:
determining a first probability of a commute associated with the at least one customer;
determining a second probability of a commute associated with at least one other customer; and
determining the level of eligibility associated with the least one customer based, at least in part, on a comparison of the first probability and the second probability.

24. The system of claim 23, wherein the first probability and the second probability is based, at least in part, on the traffic data or the weather data, wherein the traffic data provides a forecast of the traffic at a time of the calendar event, and wherein the weather data provides a forecast of the traffic at the time of the calendar event.
